(19) United States
(12) Patent Application Publication
(10) Pub. No.: US 2012/0230174 A1
(43) Pub. Date: Sep. 13, 2012

(54) OPTICAL RECORDING AND READING DEVICE AND OPTICAL RECORDING AND READING METHOD

(76) Inventors: Takashi Kikukawa, Tokyo (JP); Atsuko Kosuda, Tokyo (JP); Tomoki Ushida, Tokyo (JP); Motohiro Inoue, Tokyo (JP)

(21) Appl. No.: 13/414,948

(22) Filed: Mar. 8, 2012

(30) Foreign Application Priority Data
Mar. 9, 2011 (JP) 2009-050920

(51) Int. Cl. G11B 7/00

(52) U.S. Cl. 369/100; G9B/7

(57) ABSTRACT

In an optical recording medium, even when a plurality of recording and reading layers are stacked, deterioration in the recording and reading signal quality thereof is suppressed. Furthermore, the transfer rate thereof can be increased. When recording or reading information by means of light irradiation on or from an optical recording medium having a plurality of recording and reading layers which are stacked in advance or formed eventually, an optical recording and reading device includes: a first optical system for irradiating a first beam to recording and reading layers to be a first target to perform recording or reading of information; and a second optical system for irradiating a second beam to recording and reading layers to be a second target to perform recording or reading of information.

### BACKGROUND ART

1. Field of the Invention

The present invention relates to an optical recording and reading device and an optical recording and reading method for recording or reading information on or from an optical recording medium having a plurality of recording and reading layers by means of light irradiation.

2. Description of the Related Art

In the field of optical recording media, the recording density has been increased by employing a laser light source with a shorter wavelength and increasing the numerical aperture of an optical system. For example, in a Blu-ray Disc (BD) standard optical recording medium, a laser wavelength is set to 405 nm and a numerical aperture is set to 0.85, thereby achieving recording and reading at a capacity of 25 GB per layer. However, efforts employing these light sources or optical systems are almost reaching a limit. In order to further increase the recording capacity, volumetric recording with which information is multiply recorded in an optical axis direction has been in demand. In a BD standard optical recording medium, for example, there has been suggested a multilayer optical recording medium having 8 recording and reading layers (see Non-Patent Literature I. Ichimura et. al., Appl. Opt., 45, 1794-1803 (2006)) or a multilayer optical recording medium having 6 recording and reading layers (see Non-Patent Literature K. Mishima et. al., Proc. of SPIE, 6282, 628201 (2006)).

More recently, technical suggestions such as a ROM type optical recording medium with 20 layers (see Non-Patent Literature A. Mitsumori et. al., Jpn. J. Appl. Phys., 48, 03A055 (2009)) and a recordable optical recording medium with 10 layers or 16 layers (see Non-Patent Literature T. Kikukawa et. al., Jpn. J. Appl. Phys., 49, 08KF01 (2010), M. Inoue et. al., Proc. SPIE, 7730, 77300D (2010), M. Ogasawara et. al., Tech. Dig. of International Symposium on Optical Memory 2010, 224 (2010)) have led to an increased possibility of achieving a recording capacity of about 500 GB using an optical system (wavelength and numerical aperture) similar to that of the BD standard.

If the number of recording and reading layers is increased as in the above-described techniques, recording and reading layers are disposed in an optical recording medium over a wide range in a thickness direction thereof. As a result, a recording and reading optical pickup is required to focus a beam thereof over the wide range in the thickness direction thereof. Thus, a spherical aberration correction range thereof needs to be set wide. Therefore, there have been problems that the configuration of the optical pickup is complicated and enlarged and a seek time of a recording and reading layer by the optical pickup is prolonged.

Moreover, while an increase in the number of recording and reading layers leads to an increase in the capacity of the optical recording medium, such an increase in the number of recording and reading layers by itself does not lead to an improvement in the recording and reading speed thereof. For example, if an increase in the recording capacity of the optical recording medium is not accompanied by an improvement in the recording speed, a waiting time for a user in a recording operation is prolonged. Thus, there has been a problem that the sensory handiness is reduced.

Furthermore, if the optical characteristics of the recording and reading layers differ from one another, recording and reading powers of the optical pickup need to be finely controlled in accordance with each recording and reading layer. Particularly, as the number of recording and reading layers is increased, variations of the optical characteristics are increased. Thus, the optical pickup is required to be capable of outputting a broadband recording and reading power. As a result, there has been a problem that a cost on the optical pickup is increased.

Furthermore, when stacking a plurality of recording and reading layers in an optical recording medium, if an interlayer distance between the recording and reading layers is increased to avoid interlayer crosstalk, the above-described problems on the optical pickup become increasingly prominent. Particularly, if the number of recording and reading layers is increased while varying all the interlayer distances in order to avoid confocal crosstalk, it is necessary to prepare intermediate layers having various film thicknesses. Thus, there has been a problem that the interlayer distances turn out to be large.

### SUMMARY OF THE INVENTION

The present invention has been made in view of the above-described problems, and an object thereof is to provide an optical recording and reading device and an optical recording and reading method capable of reducing a load on a laser or an optical system and also increasing a transfer rate even if a plurality of recording and reading layers are stacked in an optical recording medium.

By virtue of the devoted researches made by the present inventors, the object stated above is achieved by the following means.

That is, the present invention that achieves the above-described object is an optical recording and reading device for recording or reading information by means of light irradiation on or from an optical recording medium having a plurality of recording and reading layers that are stacked in advance or eventually formed, the device including: a first optical system for irradiating a first beam to the recording and reading layer(s) to be a first target to perform recording or reading of information; and a second optical system for irradiating a second beam to the recording and reading layer(s) to be a second target to perform recording or reading of information.

In the optical recording and reading device that achieves the above-described object, an average emitting power of the first beam by the first optical system when recording or reading and an average emitting power of the second beam by the second optical system when recording or reading are different from each other.

In the optical recording and reading device that achieves the above-described object, a rated output of a first light source of the first optical system and a rated output of a second light source of the second optical system are different from each other.

In the optical recording and reading device that achieves the above-described object, the first optical system and the second optical system are disposed on a light incident surface side of the optical recording medium.

In the optical recording and reading device that achieves the above-described object, with reference to the light incident surface side of the optical recording medium, the recording and reading layer(s) to be the first target is placed farther than the recording and reading layer(s) to be the second target, and the average emitting power of the first beam by the first optical system when recording or reading is higher than the average emitting power of the second beam by the second optical system when recording or reading.

In the optical recording and reading device that achieves the above-described object, the optical recording medium includes a plurality of the recording and reading layers of the first target and a plurality of the recording and reading layers of the second target.

The optical recording and reading device that achieves the above-described object includes a recording and reading control device for simultaneously controlling the first and second optical systems to simultaneously record or read information on or from the recording and reading layer(s) of the first target and the recording and reading layer(s) of the second target.

In the optical recording and reading device that achieves the above-described object, an optical constant of the recording and reading layer(s) of the first target and an optical constant of the recording and reading layer(s) of the second target are substantially the same in the optical recording medium.

In the optical recording and reading device that achieves the above-described object, a material composition and a film thickness of the recording and reading layer(s) of the first target and those of the recording and reading layer(s) of the second target are substantially the same in the optical recording medium, respectively.

In the optical recording and reading device that achieves the above-described object, the optical recording medium includes at least two or more recording and reading layer groups, each group composed of a plurality of the recording and reading layers sequential in a stacking order; within the recording and reading layer group, reflectances in a stacked state of the recording and reading layers are set to be substantially the same or decreased from a side closer to a light incident surface toward a side farther from the light incident surface; and the recording and reading layer(s) of the first target and the recording and reading layer(s) of the second target belong to any of the two or more recording and reading layer groups.

In the optical recording and reading device that achieves the above-described object, the optical constants of the recording and reading layers belonging to the same recording and reading layer group are substantially the same, and the optical constant of the recording and reading layer(s) belonging to one of the plurality of recording and reading layer groups and the optical constant of the recording and reading layer(s) belonging to another one of the plurality of recording and reading layer groups are different from each other.

In the optical recording and reading device that achieves the above-described object, the recording and reading layer(s) of the first target belongs to a first one of the recording and reading layer groups, and the recording and reading layer(s) of the second target belongs to a second one of the recording and reading layer groups.

In the optical recording and reading device that achieves the above-described object, the recording and reading layers of the first target belong to two or more groups among the recording and reading layer groups, and the recording and reading layers of the second target belong to two or more groups among the recording and reading layer groups.

The present invention that achieves the above-described object is an optical recording and reading method for recording or reading information by means of light irradiation on or from an optical recording medium having a plurality of recording and reading layers that are stacked in advance or eventually formed, the method including: a first step of irradiating a first beam to the recording and reading layer(s) to be a first target to perform recording or reading of information; and a second step of irradiating a second beam to the recording and reading layer(s) to be a second target to perform recording or reading of information.

According to the optical recording and reading method that achieves the above-described object, with reference to a light incident surface side of the optical recording medium, the recording and reading layer(s) to be the first target is placed farther than the recording and reading layer(s) to be the second target; and an average emitting power of the first beam when recording or reading is higher than an average emitting power of the second beam when recording or reading.

In the optical recording and reading method that achieves the above-described object, the first step and the second step are simultaneously performed to simultaneously record or read information on or from the recording and reading layer(s) of the first target and the recording and reading layer(s) of the second target.

In the optical recording and reading method that achieves the above-described object, an optical constant of the recording and reading layer(s) of the first target and an optical constant of the recording and reading layer(s) of the second target are substantially the same in the optical recording medium.

In the optical recording and reading method that achieves the above-described object, the optical recording medium includes at least two or more recording and reading layer groups, each group composed of a plurality of the recording and reading layers sequential in a stacking order; within the recording and reading layer group, reflectances in a stacked state of the recording and reading layers are set to be substantially the same or decreased from a side closer to a light incident surface toward a side farther from the light incident surface; and the recording and reading layer(s) of the first target to be recorded or read in the first step and the recording and reading layer(s) of the second target to be recorded or read in the second step belong to any of the two or more recording and reading layer groups.

The present invention can provide beneficial effects such that, even when a plurality of recording and reading layers are stacked in an optical recording medium, a deterioration in recording and reading signal quality can be suppressed and the transfer rate thereof can be also increased.

### BRIEF DESCRIPTION OF THE DRAWINGS

FIG. 1 is a side view showing a general configuration of an optical recording and reading device and a multilayer optical recording medium according to a first embodiment of the present invention;

FIG. 2 is a block diagram showing an internal configuration of a first optical pickup of the optical recording and reading device;

FIG. 3 is a block diagram showing an internal configuration of a second optical pickup of the optical recording and reading device;

FIG. 4 is a cross-sectional view showing a stacking structure of the multilayer optical recording medium;

FIG. 5 shows a table and graphs showing reflectances and absorbances of the multilayer optical recording medium;

FIG. 6 is a chart showing a structure of film thicknesses in the multilayer optical recording medium;

FIG. 7 is a diagram showing a state of reading light for explaining a design concept of the multilayer optical recording medium;

FIG. 8 is a diagram showing a state of stray light for explaining the design concept of the multilayer optical recording medium;

FIG. 9 is a graph showing changes in stacked-layer reflectances for explaining the design concept of the multilayer optical recording medium;

FIG. 10 is a graph showing changes in stacked-layer reflectances for explaining the design concept of the multilayer optical recording medium;

FIG. 11 is a cross-sectional view for explaining an optical recording and reading method of a multilayer optical recording medium by the optical recording and reading device;

FIG. 12 shows an output waveform illustrating an example of power control by high frequency modulation of a laser;

FIG. 13 is a graph showing changes in stacked-layer reflectances for explaining a design concept of a multilayer optical recording medium to be recorded or read by an optical recording and reading device of a second embodiment;

FIG. 14 is a graph showing changes in stacked-layer reflectances for explaining the design concept of the multilayer optical recording medium;

FIG. 15 is a cross-sectional view showing a stacking structure of the multilayer optical recording medium;

FIG. 16 shows a table and graphs showing reflectances and absorbances of the multilayer optical recording medium;

FIG. 17 is a chart showing a structure of film thicknesses in the multilayer optical recording medium;

FIG. 18A shows a table and graphs showing reflectances and absorbances of the multilayer optical recording medium;

FIG. 18B is a cross-sectional view for explaining an optical recording and reading method of a multilayer optical recording medium by the optical recording and reading device;

FIG. 19A shows a table and graphs showing reflectances and absorbances of the multilayer optical recording medium;

FIG. 19B is a cross-sectional view for explaining another example of an optical recording and reading method of a multilayer optical recording medium by the optical recording and reading device;

FIG. 20 is a cross-sectional view for explaining another example of an optical recording and reading method of a multilayer optical recording medium by the optical recording and reading device;

FIG. 21 is a cross-sectional view for explaining another example of an optical recording and reading method of a multilayer optical recording medium by the optical recording and reading device;

FIG. 22 is a cross-sectional view for explaining another example of an optical recording and reading method of a multilayer optical recording medium by the optical recording and reading device.

### DETAILED DESCRIPTION OF THE PREFERRED EMBODIMENTS

Embodiments of the present invention will be described below with reference to accompanying drawings.

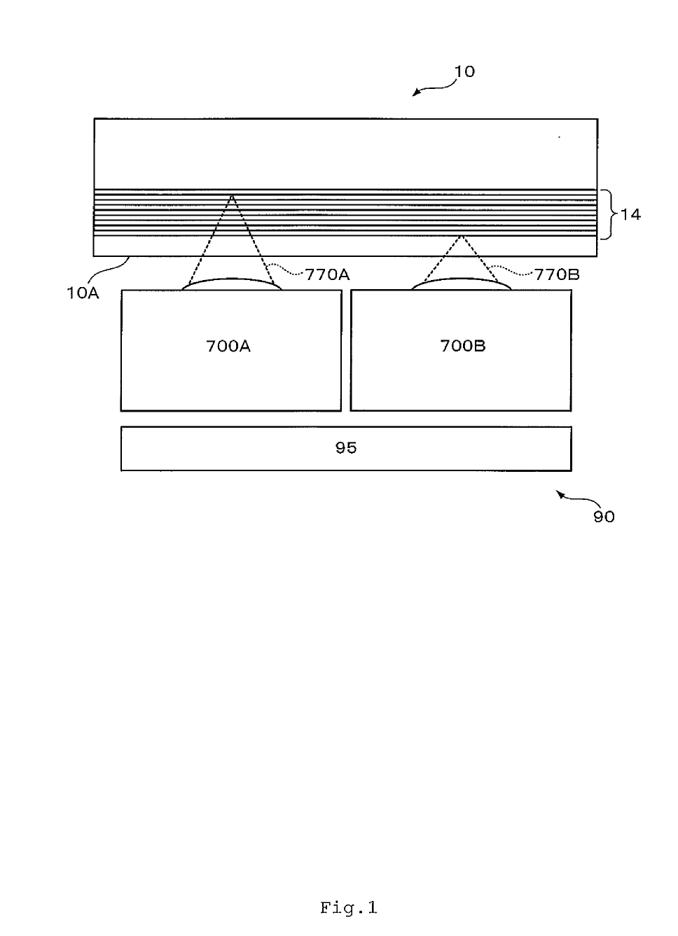

FIG. 1 shows a configuration of an optical recording and reading device 90 according to a first embodiment and a multilayer optical recording medium 10 to be recorded and read by the optical recording and reading device 90.

The optical recording and reading device 90 includes a recording and reading control device 95, a first optical pickup 700A, and a second optical pickup 700B. The first and second optical pickups 700A and 700B are disposed on the side of a light incident surface 10A which is one surface of the multilayer optical recording medium 10. These two optical pickups 700A and 700B can irradiate the inside of the multilayer optical recording medium 10 with first and second beams 770A and 770B from the light incident surface 10A so as to simultaneously record information on a recording and reading layer group 14 of the multilayer optical recording medium 10 or to simultaneously read information therefrom.

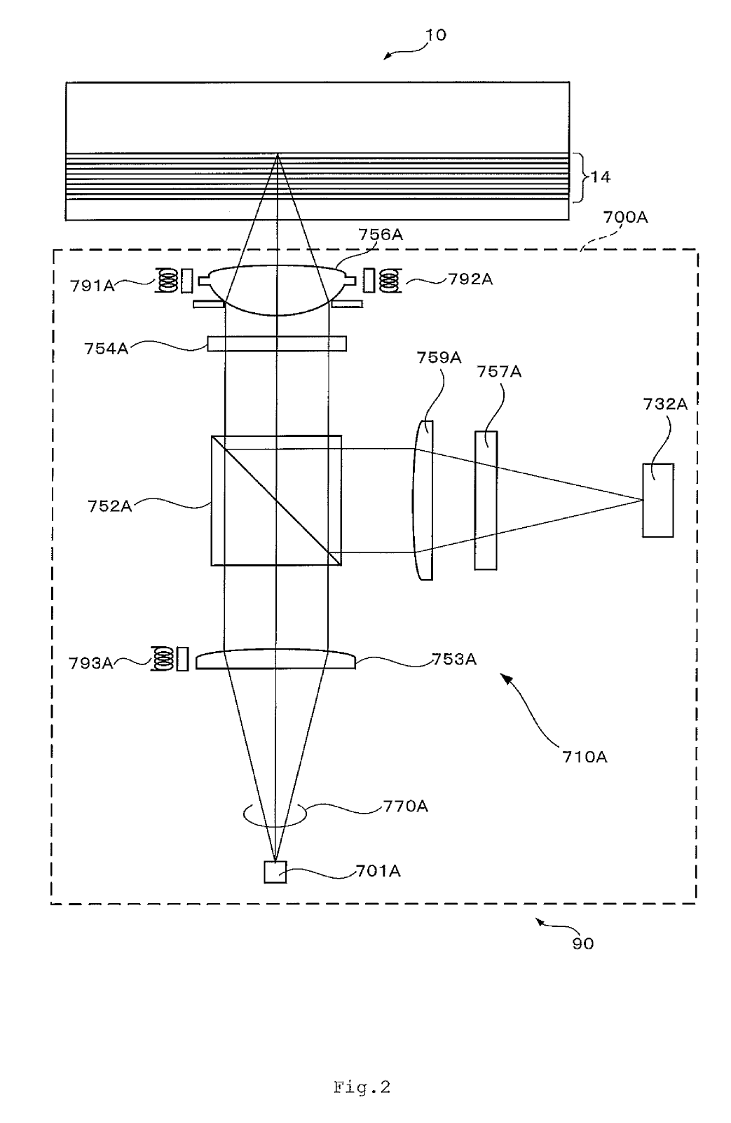

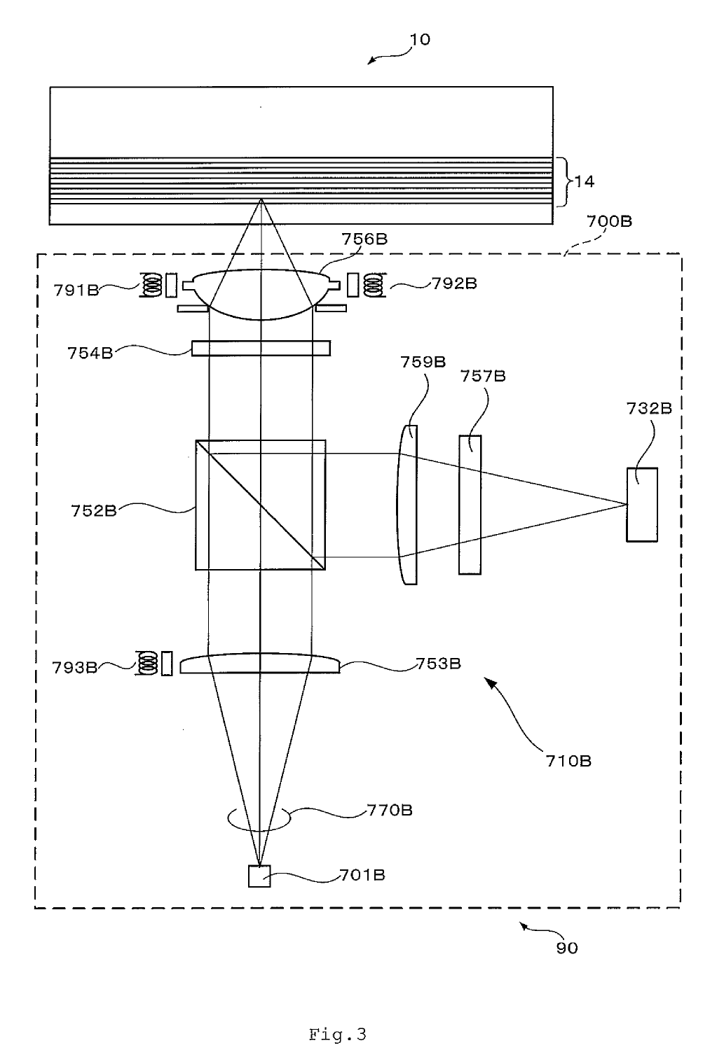

FIGS. 2 and 3 show internal configurations of the first and second optical pickups 700A and 700B, respectively. Note that the internal configurations of the first and second optical pickups 700A and 700B are generally the same partially and different from each other partially. Therefore, components and members common to each other are denoted in the first optical pickup 700A with “A” added to the end of each reference numeral in the figure or text and denoted in the second optical pickup 700B with “B” added to the end of each reference numeral in the figure or text. Except for the ends of the reference numerals, the same numbers are used. Herein, the internal configuration of the first optical pickup 700A is described in detail, and the description of the second optical pickup 700B is therefore omitted.

The first optical pickup 700A includes a first optical system 710A. The first optical system 710A is an optical system that performs recording or reading on or from the recording and reading layer group 14 of the multilayer optical recording medium 10. The divergent first beam 770A emitted from a first light source 701A and having a relatively short blue wavelength of 380 to 450 nm (herein, 405 nm) passes through a collimating lens 753A having spherical aberration correction means 793A and enters into a polarizing beam splitter 752A. The first beam 770A entering into the polarizing beam splitter 752A passes therethrough and then through a quarter wavelength plate 754A, thereby being converted to a circularly-polarized beam. The circularly-polarized beam is then converted to a convergent beam at an objective lens 756A. Such a first beam 770A is focused on one of a plurality of recording and reading layers in the recording and reading layer group 14 formed inside the multilayer optical recording medium 10.

The first beam 770A reflected by the polarizing beam splitter 752A passes through a condensing lens 759A so as to be converted to a convergent beam. The convergent beam passes through a cylindrical lens 757A and is then incident on a photodetector 732A. When the first beam 770A passes through the cylindrical lens 757A, astigmatism is given thereto. The photodetector 732A has four light receiving units (not shown in the figure), and each of the light receiving units outputs a current signal corresponding to the amount of light received. These current signals are used to generate a focus error (hereinafter, abbreviated as FE) signal using the astigmatic method, a tracking error (hereinafter, abbreviated as TE) signal using the push-pull method, a reading signal for information recorded on the multilayer optical recording medium 10, and the like. The FE signal and the TE signal are amplified to desired levels and subjected to phase compensation. Thereafter, these signals are provided, as feedback, to actuators 791A and 792A so as to perform focus control and tracking control.

The first beam 770A of the first optical system 710A in the first optical pickup 700A and the second beam 770B of a second optical system 710B in the second optical pickup 700B are set to have different average emitting powers when recording, respectively. Similarly, average emitting powers thereof when reading are set to be different from each other. Specifically, the average emitting powers of the first beam 770A when recording and when reading are set to be higher than those of the second beam 770B.

The recording and reading control device 95 simultaneously controls the first and second optical pickups 700A and 700B to record information on a recording and reading layer or to read information from the recording and reading layer. For example, focus error (hereinafter, abbreviated as FE) signals and tracking error (hereinafter, abbreviated as TE) signals obtained from the photodetectors 732A and 732B are used to perform feedback control for the actuators 791A and 791B, and 792A and 792B of the first and second optical pickups 700A and 700B, thereby performing focus control and tracking control. When recording information, while information to be recorded is sorted into the first and second optical pickups 700A and 700B, recording beams are simultaneously irradiated to two recording and reading layers from the first and second light sources 701A and 701B so as to simultaneously form recording marks thereon. When reading information, reading beams are simultaneously irradiated to two recording and reading layers from the first and second light sources 701A and 701B so as to generate reading signals based on reading waveforms obtained simultaneously from the photodetectors 732A and 732B.

When information is simultaneously recorded or simultaneously read by the first and second optical pickups 700A and 700B, it is preferable that the first and second optical pickups 700A and 700B are at the same position in a radial direction of the multilayer optical recording medium 10. This is because recording and reading can be performed with the same linear velocity when the multilayer optical recording medium 10 is rotated. Therefore, it is preferable that the first and second optical pickups 700A and 700B be placed at positions shifted from each other (different phases) in a circumferential direction of the multilayer optical recording medium 10 so as to avoid interference between the first and second optical pickups 700A and 700B.

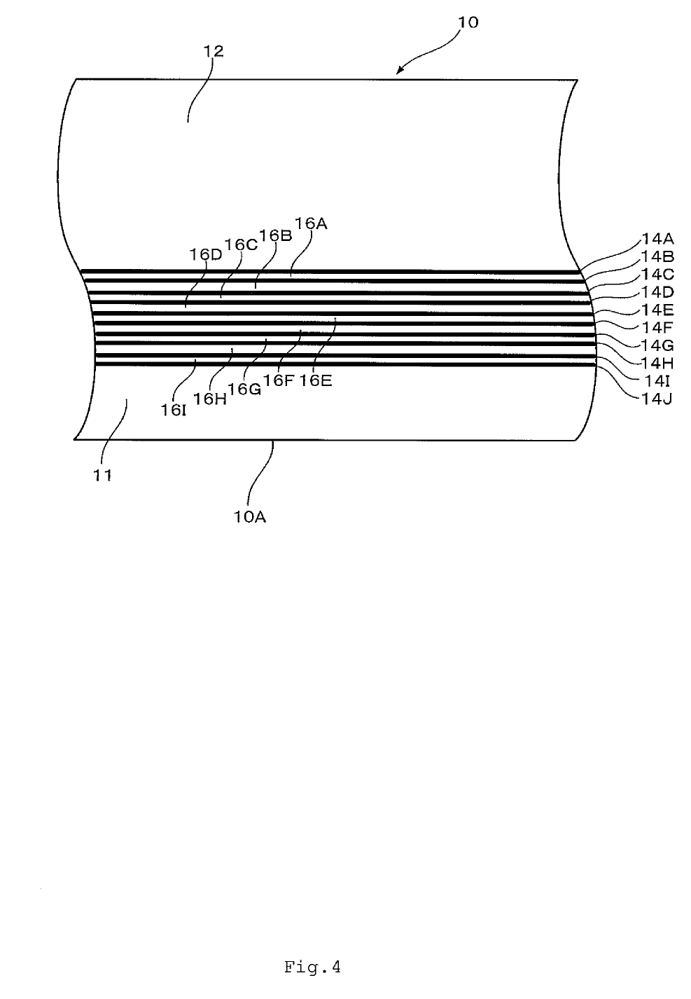

FIG. 4 shows an enlarged cross-sectional configuration of the multilayer optical recording medium 10.

The multilayer optical recording medium 10 has a disc shape having an outer diameter of approximately 120 mm and a thickness of approximately 1.2 mm, and has a configuration including three or more recording and reading layers. The multilayer optical recording medium 10 is configured to include, from the side of the light incident surface 10A: a cover layer 11; L0 to L9 recording and reading layers 14A to 14J having a configuration of 10 layers; intermediate layers 16A to 16I interposed between corresponding ones of the L0 to L9 recording and reading layers 14A to 14J, respectively; and a supporting substrate 12.

Various materials can be used for the supporting substrate 12. For example, glasses, ceramics, and resins can be used. Among these, resins are preferable in terms of molding easiness. Examples of resins include a polycarbonate resin, an olefin resin, an acrylic resin, an epoxy resin, a polystyrene resin, a polyethylene resin, a polypropylene resin, a silicone resin, a fluororesin, an ABS resin, and a urethane resin. Among these, a polycarbonate resin or an olefin resin is particularly preferable in terms of the processability thereof. Note that the supporting substrate 12 is not required to have a high light-transmitting property since it is outside an optical path of the beam 770.

Grooves having a track pitch of 0.32 μm are provided on the L0 to L9 recording and reading layers 14A to 14J. Reflectances in the stacked state of the L0 to L9 recording and reading layers 14A to 14J (completed state of the multilayer optical recording medium 10) (hereinafter, referred to as stacked-layer reflectances) decrease from the light incident surface toward the farther side therefrom. That is, the stacked-layer reflectance of the L9 recording and reading layer 14J nearest to the light incident surface is the highest, and the stacked-layer reflectance of the L0 recording and reading layer 14A is the lowest.

As a film design for achieving the stacked-layer reflectances as described above, each of the L0 to L9 recording and reading layers 14A to 14J is optimized for reflectance, absorbance, and the like, in a single-layer state in accordance with the beam 770 having a blue wavelength range in the optical system 710. In the present embodiment, optical constants are set substantially the same in all of the L0 to L9 recording and reading layers 14A to 14J, and material compositions and film thicknesses are therefore set substantially the same in all of the L0 to L9 recording and reading layers 14A to 14J.

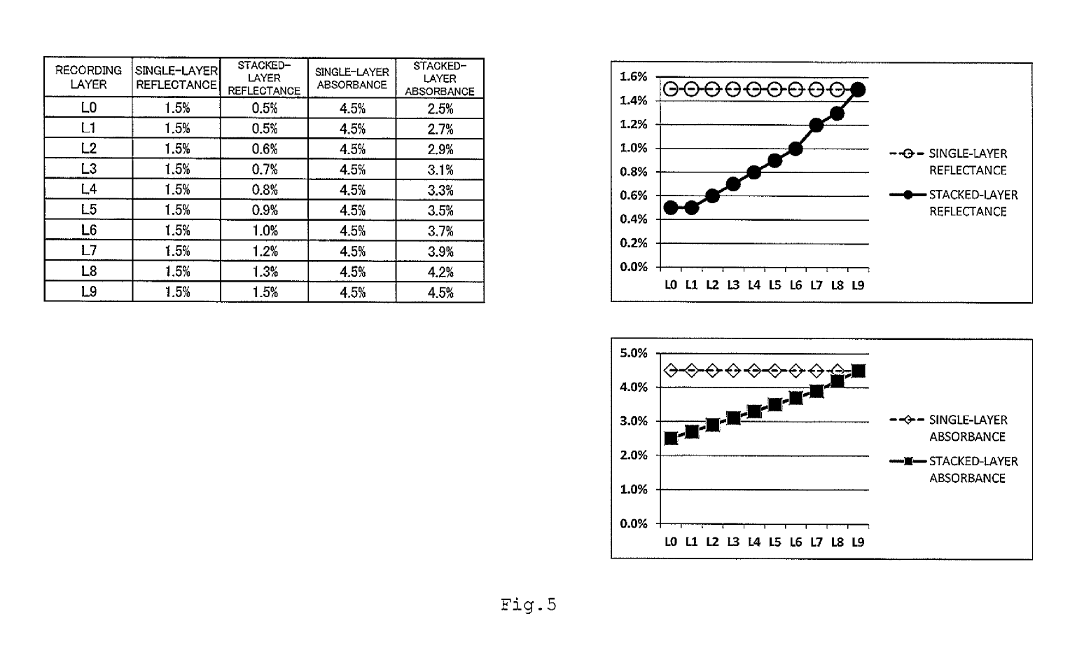

In particular, a reflectance in a single-layer state (hereinafter, referred to as a single-layer reflectance) in each of the L0 to L9 recording and reading layers 14A to 14J is set to 1.5%, and an absorbance in a single-layer state (hereinafter, referred to as a single-layer absorbance) is set to 4.5% as shown in FIG. 5.

As described above, the L0 to L9 recording and reading layers 14A to 14J are set to have approximately the same single-layer reflectances and single-layer absorbances in the present embodiment. As a result, the stacked-layer reflectances in the L0 to L9 recording and reading layers 14A to 14J monotonically decrease in the order starting from the light incident surface side.

As a result of employing such a film design, the L0 to L9 recording and reading layers 14A to 14J can be formed using substantially the same recording material and film thickness, thereby achieving a substantial reduction in the manufacturing cost thereof.

Note that each of the L0 to L9 recording and reading layers 14A to 14J has a structure of three to five layers (not shown in the figure) in which dielectric films or the like are stacked on both of the outer sides of a recordable recording film. The dielectric films in each of the recording and reading layers serve to increase a difference in optical characteristics between before and after the formation of a recording mark and to improve a recording sensitivity, in addition to a basic function of protecting the recordable recording film.

In a case where the first and second beams 770A and 770B are irradiated, if an energy to be absorbed into the dielectric films is large, the recording sensitivity is likely to decrease. Thus, in order to prevent such a reduction, it is preferred to select a material having a low absorption coefficient (k) in a wavelength range of 380 nm to 450 nm (especially 405 nm) as a material for these dielectric films. Note that TiO₂ is used as a material for these dielectric films in the present embodiment.

The recordable recording film interposed between the dielectric films is a film on which an irreversible recording mark is formed. Reflectances for the first and second beams 770A and 770B significantly differ between a portion on which a recording mark is formed and the other remaining portion (blank region). As a result, recording and reading of data can be performed.

The recordable recording film is formed from a material containing Bi and O as a main component. The recordable recording film functions as an inorganic reaction film, and the reflectance thereof significantly varies in response to a chemical or physical change due to the heat of a laser light. A specific preferred material therefor is a material having Bi—O as a main component or a material having Bi-M-O (wherein M is at least one element selected from among Mg, Ca, Y, Dy, Ce, Tb, Ti, Zr, V, Nb, Ta, Mo, W, Mn, Fe, Zn, Al, In, Si, Ge, Sn, Sb, Li, Na, K, Sr, Ba, Sc, La, Nd, Sm, Gd, Ho, Cr, Co, Ni, Cu, Ga, and Pb) as a main component. Note that Bi—Ge—O is used as a material for the recordable recording film in the present embodiment.

Although there is herein shown a case where the recordable recording films are employed in the L0 to L9 recording and reading layers 14A to 14J, it is also possible to employ a phase-change recording film capable of being recorded repeatedly. The phase-change recording film in such a case is preferably formed from SbTeGe.

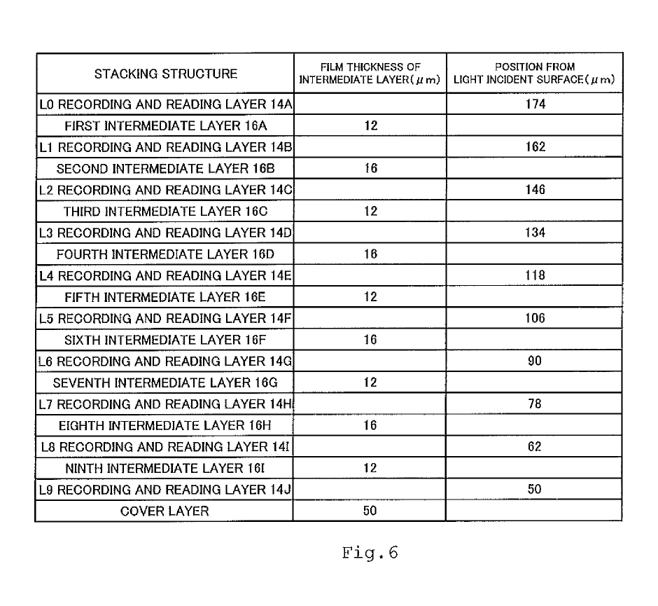

As shown in FIG. 6, the multilayer optical recording medium 10 of the present embodiment includes first to ninth intermediate layers 16A to 16I in the order starting from the farthest side from the light incident surface 10A. Each of these first to ninth intermediate layers 16A to 16I is stacked between corresponding ones of the L0 to L9 recording and reading layers 14A to 14J. Each of the intermediate layers 16A to 16I is made of an acrylic or epoxy ultraviolet curable resin. Film thicknesses of the intermediate layers 16A to 16I are set to have a first distance T1 greater than or equal to 10 μm and a second distance T2 greater than the first distance by 3 μm or more in an alternate manner. Specifically, a difference between the first distance T1 and the second distance T2 is preferably in a range between 3 μm and 5 μm, and more preferably 4 μm or more.

In the multilayer optical recording medium 10, the first distance T1 is set to 12 μm and the second distance T2 is set to 16 μm. In the order starting from the farthest side, the first intermediate layer 16A is 12 μm, the second intermediate layer 16B is 16 μm the third intermediate layer 16C is 12 μm, the fourth intermediate layer 16D is 16 μm the fifth intermediate layer 16E is 12 μm the sixth intermediate layer 16F is 16 μm the seventh intermediate layer 16G is 12 μm the eighth intermediate layer 16H is 16 μm and the ninth intermediate layer 16I is 12 μm. That is, the intermediate layers having two kinds of film thicknesses (16 μm and 12 μm) are stacked in an alternate manner. Accordingly, it is possible to reduce both of interlayer crosstalk and confocal crosstalk.

The cover layer 11 is made of a light-transmitting acrylic ultraviolet curable resin as with the intermediate layers 16A to 16I, and a film thickness thereof is set to 50 μm.

Next, a design concept of the multilayer optical recording medium 10 will be described while generalizing the number of recording and reading layers.

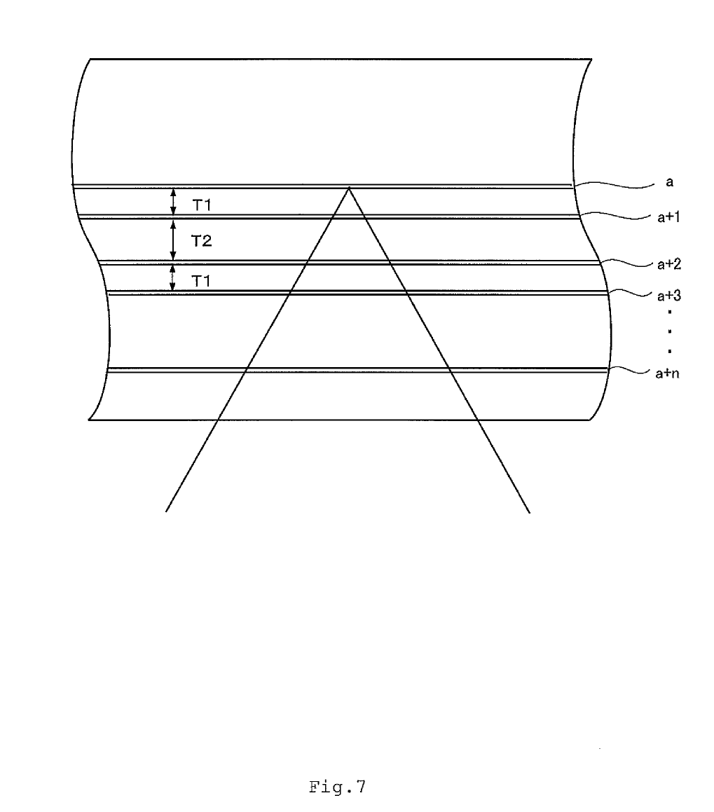

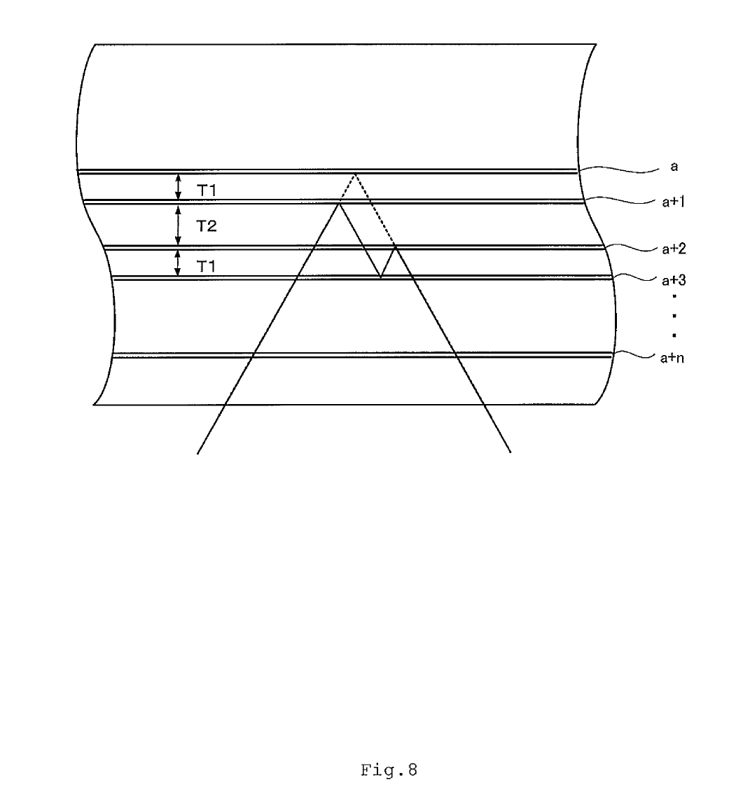

Suppose a case where there are two kinds (T1 and T2) of thicknesses for intermediate layers disposed between recording and reading layers in a multilayer optical recording medium and these thicknesses are stacked in an alternate manner. In FIG. 7, in a case where an a-th recording and reading layer is read, a path of a reading light (the present light) directly reflected at this recording and reading layer is shown. Also, FIG. 8 shows an example for a path of a stray light whose optical path length coincides with that of the present light. In regard to a material which forms a k-th recording and reading layer, it is herein defined that a reflectance and a transmittance thereof in a single-layer state are rₖ and tₖ, respectively.

If it is defined that an intensity of the present light when a reading light having an intensity of “1” is made incident on the a-th recording and reading layer is Iₐ and an intensity of a stray light is Iₐ′, Iₐ and Iₐ′ are expressed as the following Expressing 1 and Expressing 2.

Iₐ=(tₐ₊₁×tₐ₊₂×tₐ₊₃× . . . ×tₐ₊ₙ)²×rₐ [Expressing 1]

$$\begin{matrix}{I}_{a}^{′} = ( {t}_{a + 2} \times {t}_{a + 3} \times … \times {t}_{a + n} ) \times {r}_{a + 1} \times {t}_{a \times 2} \times \\ {r}_{a + 3} \times {r}_{a + 2} \times ( {t}_{a + 3} \times … \times {t}_{a + n} ) \\ = {( {t}_{a + 2} \times {t}_{a + 3} \times … \times {t}_{a + n} )}^{2} \times {r}_{a + 1} \times {r}_{a + 2} \times {r}_{a + 3}\end{matrix} \qquad [ Expressing 2 ]$$

Therefore, an intensity ratio (Iₐ′/Iₐ) of the stray light to the present light can be expressed as Expression 3.

Iₐ′/Iₐ=(tₐ₊₂×tₐ₊₃× . . . ×tₐ₊ₙ)²×rₐ₊₁×rₐ₊₂×rₐ₊₃/(tₐ₊₁×tₐ₊₂×tₐ₊₃× . . . ×tₐ₊ₙ)²×rₐ=(rₐ₊₁×rₐ₊₂×rₐ₊₃)/(tₐ₊₁²×rₐ) [Expression 3]

As described above, in the multilayer optical recording medium having the two kinds of intermediate layer thicknesses disposed in an alternate manner, it can be seen that the following three ideas are effective in order to reduce an influence of confocal crosstalk in the a-th recording and reading layer, i.e., in order to reduce the intensity ratio of the stray light in [Expression 3].

(1) To increase the reflectance rₐ of the a-th layer.
(2) To reduce the reflectances rₐ₊₁, rₐ₊₂, and rₐ₊₃ of an a+1-th layer, an a+2-th layer, and an a+3-th layer (the three layers adjacent to the a-th layer on the side of (closer to) the light incident surface).
(3) To increase the transmittance tₐ₊₁ of the a+1-th layer (the one layer adjacent to the a-th recording and reading layer and closer to the light incident surface).

Furthermore, in order for these ideas to be true in all of the recording and reading layers, it is only necessary to reduce the reflectances of all the recording and reading layers excluding a recording and reading layer that cannot be positioned closer to the light incident surface than any of the other recording and reading layers, i.e., the recording and reading layer farthest from the light incident surface and to increase the transmittances thereof. In order to achieve this, it is extremely simple, in view of the medium design, to set the reflectances r and the transmittances t in a single-layer state to be identical to one another for all of the recording and reading layers excluding the farthest recording and reading layer. Then, the reflectance r of each recording and reading layer is set to be low and the transmittance t thereof is set to be high. Needless to say, the medium design can be simplified most if the reflectances r and the transmittances t in all of the recording and reading layers including the farthest recording and reading layer are set to be identical to one another, although the effect of reducing the stray light in the farthest recording and reading layer is reduced.

As described above, if optical constants are made equal to one another, i.e., the reflectances r and the transmittances t are made equal to one another among different recording and reading layers, respectively, a reflectance R in a stacked state is observed to be lower as the recording and reading layer is positioned farther in the multilayer optical recording medium. Thus, assuming that the reflectances r and the transmittances t are set equal to one another in all of the recording and reading layers, the stacked-layer reflectances R monotonically decrease from the closest recording and reading layer toward the farthest recording and reading layer. Note that the reflectance in a stacked state refers to a reflectance obtained from a ratio between an incident light and a reflected light when a light is irradiated to a particular recording and reading layer in the completed multilayer optical recording medium.

In order for a plurality of recording and reading layers to have the same optical constant, it is convenient to employ the same composition and the same film thickness in recording materials that form the plurality of recording and reading layers. Accordingly, a load is reasonably reduced in terms of the medium design and also in terms of the manufacturing thereof. Therefore, in order to realize the conceptual idea of the multilayer optical recording medium according to the present invention, it is desirable to employ the same composition and the same film thickness for the recording materials that form the plurality of recording and reading layers. More preferably, material compositions and film thicknesses are made substantially the same in all of the recording and reading layers including the recording and reading layer farthest from the light incident surface, thereby making the optical constants thereof the same.

The compositions and film thicknesses for the respective recording and reading layers being substantially the same in the multilayer optical recording medium has the same meaning as that results obtained by measuring, with a transmission electron microscope (TEM) or a scanning electron microscope (SEM), film thicknesses of disc samples cut in a cross-sectional direction thereof using a microtome and by further analyzing the compositions thereof using an energy dispersive spectroscopy adjunct to these microscopes are substantially approximately the same among the respective recording and reading layers. If such a state exists, the material compositions and film thicknesses can be regarded as the same among the respective recording and reading layers. Needless to say, the optical constants thereof are thereby identical to one another among the respective recording and reading layers.

By the way, since the transmittance tₖ takes a value greater than 0 and smaller than 1, the reflected light intensity Iₐ decreases as the number of recording and reading layers, n+1, increases. If the reflected light intensity Iₐ is too low, the signal-noise ratio (SNR) becomes too small, thereby reaching a sensitivity limit for the photodetector of the optical pickup. In principle, the upper limit in the number of the recording and reading layers is determined by this sensitivity limit.

In particular, at the designing phase, the maximum stacking number is the resultant number obtained by stacking the recording and reading layers having the same optical constants in the order starting from the light incident surface side toward the farther side therefrom until the stacked-layer reflectance R reaches the sensitivity limit which can be dealt with by the optical pickup.

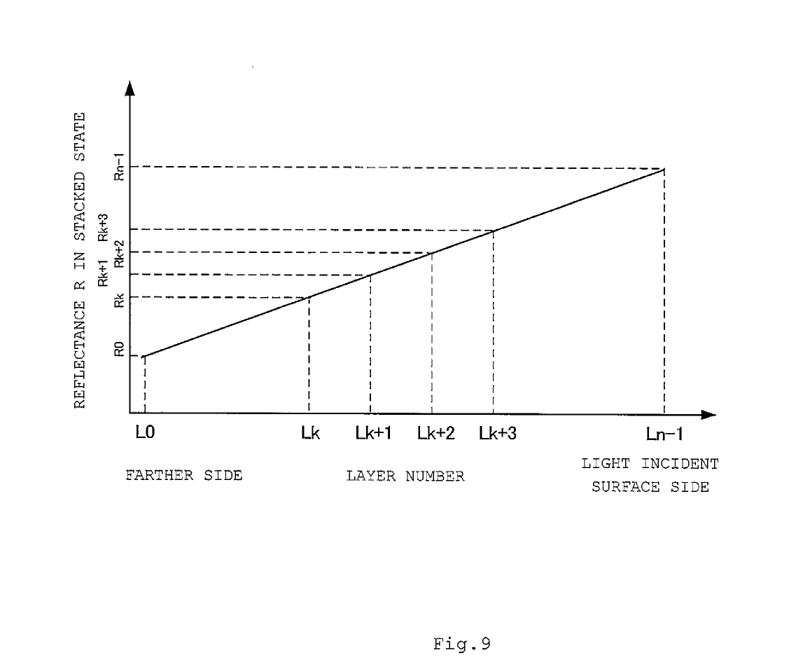

FIG. 9 shows a state where the multilayer optical recording medium is configured based on the above-described conceptual idea. The stacked-layer reflectance R monotonically decreases from the recording and reading layer (Lₙ₋₁ layer) positioned closest to the light incident surface toward the recording and reading layer (L₀) positioned farthest from the light incident surface through the intermediate recording and reading layers (Lₖ₊₁ layer, Lₖ layer, and Lₖ₋₁ layer).

The ratio of the stacked-layer reflectances (Rₙ₋₁ and R₀) in the recording and reading layer (Lₙ₋₁ layer) positioned closest to the light incident surface and the recording and reading layer (L₀ layer) positioned farthest therefrom is determined from a limit in dynamic ranges of the same reflectance which can be dealt with by the first and second optical pickups 700A and 700B. Particularly in the present embodiment, the first and second optical pickups 700A and 700B perform recording or reading on or from different recording and reading layers. Thus, it is possible to widen an overall dynamic range obtained by combining a dynamic range of the first optical pickup 700A and that of the second optical pickup 700B. As a result, it is possible to increase the number of recording and reading layers.

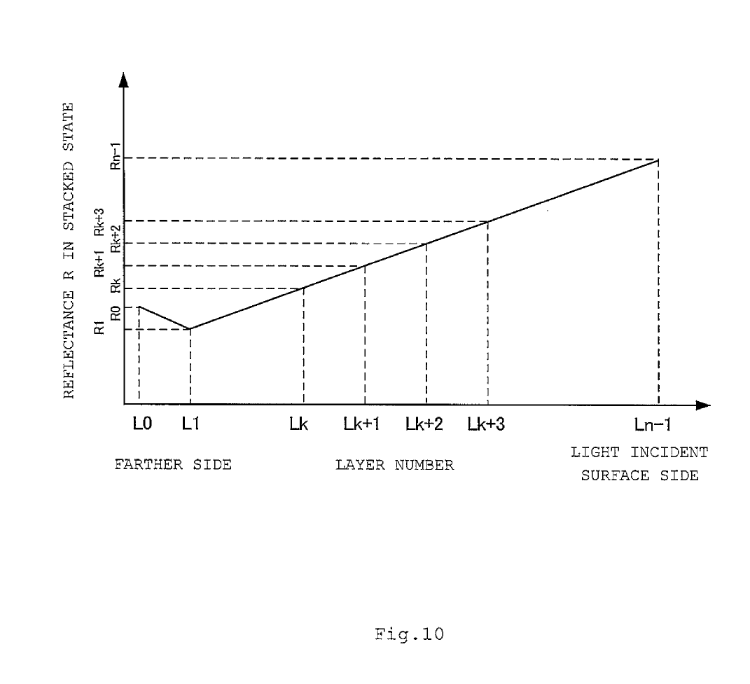

Although FIG. 9 shows, by way of example, the concept for setting the optical constants for all of the recording and reading layers to be the same, optical constants may not be set equal to each other as shown in FIG. 10 by employing, for the farthest recording and reading layer (L₀ layer), a material composition and a film thickness different from those in the remaining recording and reading layers. This is because the L₀ layer is not required to give consideration to the light transmittance thereof due to the absence of a recording and reading layer positioned farther than that.

Also in regard to the multilayer optical recording medium 10 shown in FIG. 4, a particular deposition condition is designed for the L9 recording and reading layer 14J closest to the light incident surface 10A, and recording and reading layers are stacked in the order starting from the light incident surface 10A toward the farther side therefrom on the basis of the L9 recording and reading layer 14J. The upper limit in the number of stacked recording and reading layers is preferably determined by either (1) or (2) below. (1) When a recording and reading layer is irradiated with reading light with a power just enough to prevent reading deterioration, an amount of reflected light returned to the photodetector 732 due to the reflection from each recording and reading layer approaches a limit value that can be dealt with by an evaluation apparatus. (2) To be closer to a laser power limit value (i.e., a recording sensitivity limit value) necessary to form a recording mark in a recording and reading layer (to modify a recording layer). That is, if the farthest recording and reading layer reaches these limit values for the amount of reflected light and the recording sensitivity, it is an upper limit in the number of stacked layers. When recording and reading layers each having the same configuration are stacked, the amounts of reflected light returned to the photodetector 732 from the respective recording and reading layers in a stacked state monotonically decrease toward the farther side from the light incident surface in proportion to the square of a transmittance in a recording and reading layer. Furthermore, laser powers reaching to the respective recording and reading layers also decrease in proportion to the transmittances.

Next, a method for manufacturing the multilayer optical recording medium 10 will be described. First, an injection molding method of a polycarbonate resin using a metal stamper is used to produce the supporting substrate 12 including grooves and lands formed thereon. Note that the production of the supporting substrate 12 is not limited to the injection molding method, and the 2P method or another method may be used for the production thereof.

Thereafter, the L0 recording and reading layer 14A is formed on a surface of the supporting substrate 12 on which the grooves and the lands are provided.

In particular, a dielectric film, a recordable recording film, and a dielectric film are formed in this order using a vapor deposition method. It is particularly preferred to use a sputtering method. Thereafter, the first intermediate layer 16A is formed on the L0 recording and reading layer 14A. For example, the first intermediate layer 16A is formed by coating a viscosity-controlled ultraviolet curable resin with a spin coating method or the like, then molding grooves and lands using a stamper, and then irradiating the ultraviolet curable resin with ultraviolet rays for curing. By repeating such a procedure, the L1 recording and reading layer 14B, the second intermediate layer 16B, the L2 recording and reading layer 14C, the third intermediate layer 16C, are stacked in order.

If layers up to the L9 recording and reading layer 14J are completed, the cover layer 11 is formed thereon to complete the multilayer optical recording medium 10. Note that the cover layer 11 is formed, for example, by coating a viscosity-controlled acrylic or epoxy ultraviolet curable resin with the spin coating method or the like and irradiating the ultraviolet curable resin with ultraviolet rays for curing. Although the above-described manufacturing method has been explained in the present embodiment, the present invention is not limited particularly to the above-described manufacturing method and other manufacturing techniques may be employed.

In this multilayer optical recording medium 10, the stacked-layer reflectances of the L0 to L9 recording and reading layers 14A to 14J decrease from the closer side toward the farther side. Thus, when reading a particular recording and reading layer, it is possible to suppress the reflected light of the recording and reading layer adjacent thereto on the farther side from mixing with the reading light. As a result, even if a thickness of the intermediate layer is reduced, crosstalk can be suppressed. Thus, the stacking number of the L0 to L9 recording and reading layers 14A to 14J can be increased up to 10 layers.

Moreover, the same film materials and the same film thicknesses are employed among the L0 to L9 recording and reading layers 14A to 14J in the present embodiment. Thus, the respective recording and reading layers do not have to set different deposition conditions, whereby the design load and the manufacturing load can be reduced significantly. As a result, optical constants are set substantially the same among the L0 to L9 recording and reading layers 14A to 14J. Accordingly, a variation in recording and reading conditions on the side of the optical recording and reading device 90 is reduced, thereby being able to simplify recording and reading control (recording strategy). Incidentally, if various recording and reading layers having different single-layer reflectances and single-layer absorbances, respectively, are intricately stacked, optimum recording and reading control needs to be found out empirically. Thus, there will be considerable difficulty.

Next, an optical recording and reading method by the optical recording and reading device 90 of the first embodiment will be described.

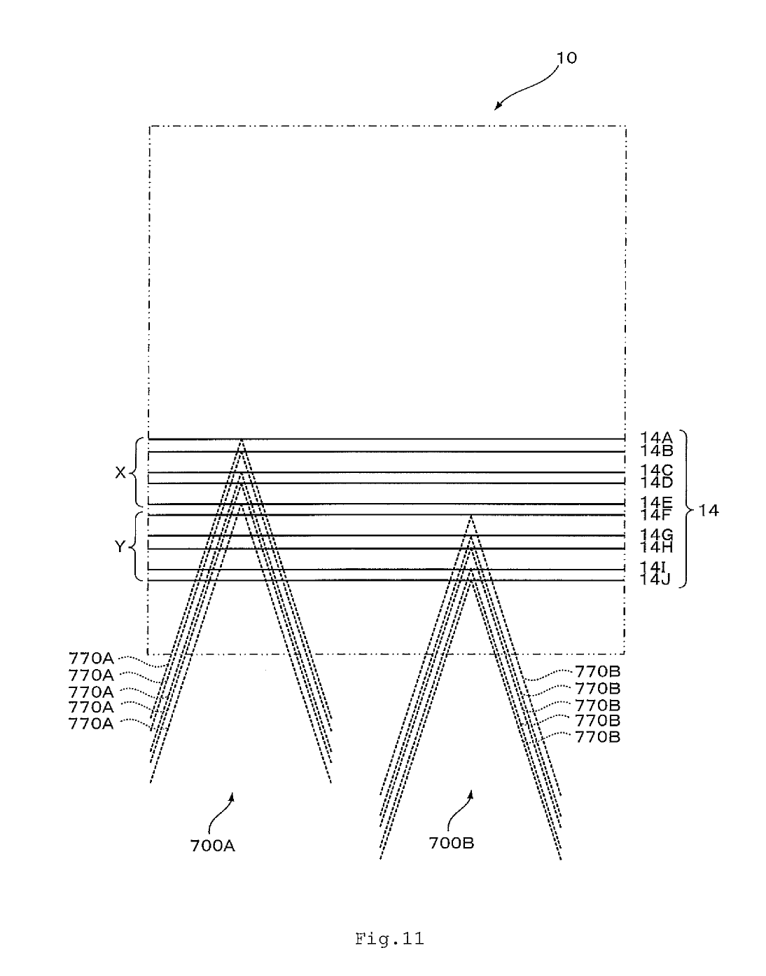

As shown in FIG. 11, the first beams 770A of the first optical pickup 700A in the optical recording and reading device 90 perform recording or reading on or from the L0 to L4 recording and reading layers 14A to 14E in the recording and reading layer group 14. Also, the second beams 770B of the second optical pickup 700B perform recording or reading on or from the L5 to L9 recording and reading layers 14F to 14J. Note that the recording and reading layers to be recorded or read by the first beams 770A are hereinafter referred to sometimes as a recording and reading layer to be a first target, or a first target recording and reading layer. Also, the recording and reading layers to be recorded or read by the second beams 770B are hereinafter referred to sometimes as a recording and reading layer to be a second target or a second target recording and reading layer.

That is, in the present optical recording and reading method, the first target L0 to L4 recording and reading layers 14A to 14E and the second target L5 to L9 recording and reading layers 14F to 14J are different recording and reading layers. Particularly in the present embodiment, with reference to the light incident surface 10A side of the multilayer optical recording medium 10, the first target L0 to L4 recording and reading layers 14A to 14E are placed farther than the second target L5 to L9 recording and reading layers 14F to 14J. Moreover, average emitting powers of the first beams 770A for irradiating the first target L0 to L4 recording and reading layers 14A to 14E when recording and when reading are higher than average emitting powers of the second beams 770B for irradiating the second target L5 to L9 recording and reading layers 14F to 14J when recording and when reading.

As previously mentioned, the material composition and the film thickness in the first target L0 to L4 recording and reading layers 14A to 14E are substantially the same as those in the second target L5 to L9 recording and reading layers 14F to 14J. As a result, optical constants of the first target L0 to L4 recording and reading layers 14A to 14E are substantially the same as those of the second target L5 to L9 recording and reading layers 14F to 14J.

As described above, according to the optical recording and reading device 90 of the present embodiment, the first optical pickup 700A and the second optical pickup 700B are separately provided. Thus, information can be simultaneously recorded or read by irradiating the L0 recording and reading layer 14A with the first beam 770A and irradiating the L5 recording and reading layer 14F with the second beam 770B at the same time. Accordingly, an information transfer rate when recording or reading can be significantly improved. Thus, even if the number of stacked layers in the multilayer optical recording medium 10 is increased, a waiting time for a user when recording is shortened. Thus, sensory handiness is improved.

Moreover, in the optical recording and reading device 90, the first optical pickup 700A performs recording or reading on or from the L0 to L4 recording and reading layers 14A to 14E on the side farther from the light incident surface 10A of the multilayer optical recording medium 10, and the second optical pickup 700B performs recording or reading on or from the closer-side L5 to L9 recording and reading layers 14F to 14J. That is, the L0 to L4 recording and reading layers 14A to 14E to be a recording and reading target for the first optical pickup 700A concentrate in a region X on the farther side in a thickness direction of the multilayer optical recording medium 10. The L5 to L9 recording and reading layers 14F to 14J to be a recording and reading target for the second optical pickup 700B concentrate in a region Y on the closer side in the thickness direction of the multilayer optical recording medium 10. As a result, each of the first and second optical pickups 700A and 700B can reduce a focus moving range thereof, thereby narrowing a spherical aberration correction range thereof. As a result, the configurations of the first and second optical systems 710A and 710B need not be complicated and expanded. Furthermore, it becomes possible to increase the number of recording and reading layers beyond a dynamic range limitation in each of the first and second optical pickups 700A and 700B. Even if the number of recording and reading layers is increased, moving distances of the first and second beams 770A and 770B are small. Therefore, a recording and reading layer selection speed is increased.

Note that in the multilayer optical recording medium 10 of the present embodiment, the L0 to L9 recording and reading layers 14A to 14J are set to have approximately the same single-layer reflectances and single-layer absorbances. As a result, the stacked-layer reflectances of the L0 to L9 recording and reading layers 14A to 14J are monotonically decreased in the order starting from the light incident surface 10A side. Accordingly, if grouping of recording and reading layers is performed using a predetermined stacked-layer reflectance as a threshold, the recording and reading layers are spontaneously grouped into the farther-side region X and the closer-side region Y which are different from each other in the thickness direction. That is, an extremely reasonable optical recording and reading method is achieved by combining the technique to monotonically increase or decrease a stacked-layer reflectance in the multilayer optical recording medium 10 with the recording and reading technique in which the stacked-layer reflectance is used as a threshold to make a recording and reading layer having a stacked-layer reflectance smaller than or equal to the threshold belong to the first target and make a recording and reading layer having a stacked-layer reflectance greater than or equal to the threshold belong to the second target.

Moreover, if the groupings of the first and second target recording and reading layers are performed on the basis of the magnitude of a stacked-layer reflectance, it is possible to reduce a required range of a recording and reading power which has to be met by each of the first and second optical pickups 700A and 700B. As a result, the manufacturing costs of the first and second optical pickups 700A and 700B can be substantially suppressed. In particular, the first light source 701A in the first optical pickup 700A may be a high power output-dedicated laser in the rating thereof, and the second light source 701B in the second optical pickup 700B may be a low power output-dedicated laser in the rating thereof. Then, an average emitting power of the first beams 770A to be irradiated to the first target L0 to L4 recording and reading layers 14A to 14E when recording can be made a high power, and an average emitting power of the second beams 770B to be irradiated to the second target L5 to L9 recording and reading layers 14F to 14J when recording can be made a low power.

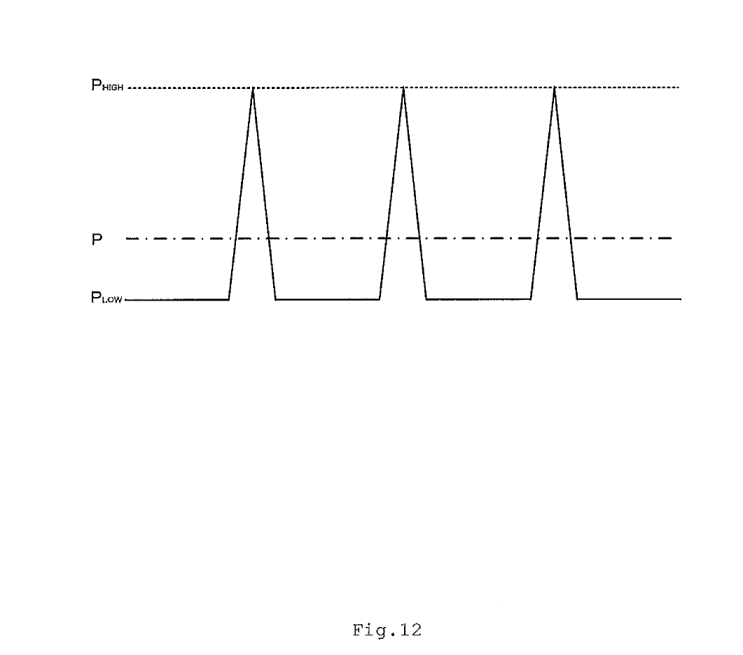

If a range from a high power to a low power needs to be covered only by one light source as in the conventional technique, it is necessary to employ an expensive laser capable of outputting a high bandwidth power. Moreover, when a low-power beam is irradiated using the laser corresponding to a high bandwidth power, it is necessary to perform high frequency modulation as shown in FIG. 12 as a measure against noise. The high frequency modulation is a technique such that beam irradiation by the minimum power P_{LOW} is used as a base and hundreds of picoseconds of a high frequency pulse with a high power P_{HIGH} is superimposed thereon to generate a beam with a required low power P by an integral average thereof. If this technique is employed, the multilayer optical recording medium 10 is more likely to deteriorate due to the high frequency pulse with the high power P_{HIGH} in addition to the complication of a laser driving circuit thereof. On the other hand, the present embodiment can eliminate the need to control high frequency modulation by employing different dedicated lasers having respectively different rated outputs as the first light source 701A and the second light source 701B.

Next, an optical recording and reading method according to the second embodiment will be described. Since the optical recording and reading device 90 used in the second embodiment is the same as that of the first embodiment, a detailed description and illustration of the internal configuration thereof will be omitted. On the other hand, a design concept of a multilayer optical recording medium used in the second embodiment differs from that in the first embodiment. Therefore, the design concept of the multilayer optical recording medium in the second embodiment will be described first.

As described in the design theory of the above-described first embodiment, the transmittance tₖ of the multilayer optical recording medium 10 takes a value greater than 0 and smaller than 1. Therefore, as the number of recording and reading layers, n+1, increases, the reflected light intensity Iₐ decreases. If the reflected light intensity Iₐ is too low, the signal-noise ratio (SNR) becomes too small, thereby reaching a sensitivity limit for the photodetector of the optical pickup. Therefore, as long as all of the recording and reading layers are set to have one composition and one film thickness, there is a limit in increasing the number of recording and reading layers.

In view of this, according to the design concept of the second embodiment, a first recording material and a first film thickness are employed first to stack recording and reading layers each having the same optical constant in the order starting from the light incident surface side toward the farther side therefrom. When the stacked-layer reflectance R reaches a lower limit that can be dealt with by the optical pickup, a different recording material and a different film thickness are employed (second new recording material and film thickness are employed) starting from the next farther-side recording and reading layer. In particular, the single-layer reflectance r thereof is set to be higher than that in the closer-side recording and reading layer by a predetermined value or more. Accordingly, since the stacked-layer reflectance R in such a recording and reading layer is increased (shifted to an increase), the optical pickup comes to be able to deal with it again. Therefore, the second recording material and film thickness are employed to further stack recording and reading layers in order toward the farther side up to the lower sensitivity limit that can be dealt with by the optical pickup. By repeating such a design process, it is possible to reduce a variation (a difference between the maximum value and the minimum value) in reflectances R in a stacked state among all of the recording and reading layers. It is also possible to reduce the kinds of the recording and reading layers (kinds in material composition and film thickness). That is, in the optical recording and reading method according to the second embodiment, the multilayer optical recording medium employs approximately the same material compositions and film thicknesses to group recording and reading layers with optical constants thereof identical to each other into a recording and reading layer group, and a plurality of such recording and reading layer groups are prepared.

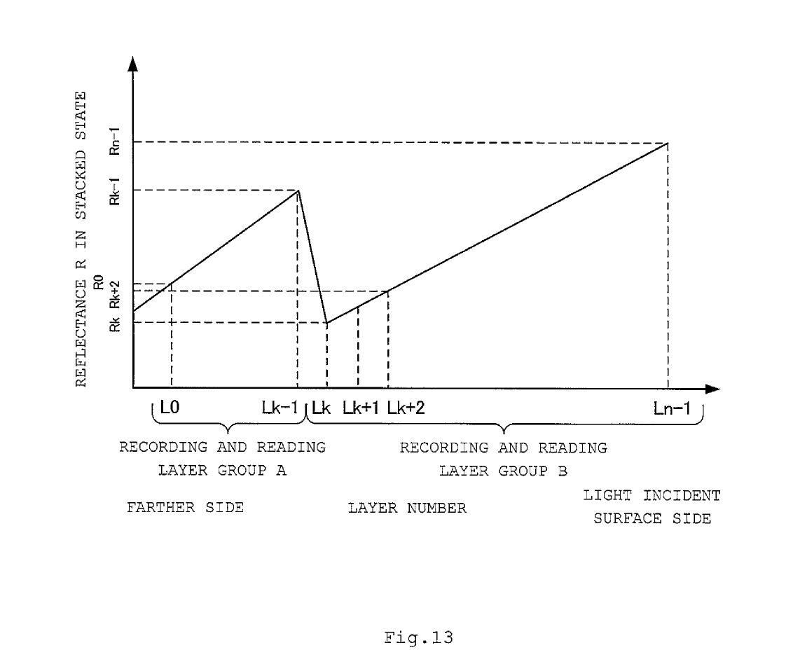

Based on this idea, the concept of forming a multilayer optical recording medium by two recording and reading layer groups A and B is shown in FIG. 13. In the recording and reading layer group B closest to a light incident surface side, stacked-layer reflectances R are monotonically decreased from a recording and reading layer (Lₙ₋₁ layer) positioned closest to the light incident surface side toward a recording and reading layer (L_{K}) positioned farthest therefrom. Similarly, in the recording and reading layer group A adjacent to the farther side of the recording and reading layer group B, stacked-layer reflectances R are monotonically decreased from a recording and reading layer (Lₖ₋₁ layer) positioned closest to the light incident surface side toward a recording and reading layer (L₀) positioned farthest therefrom.

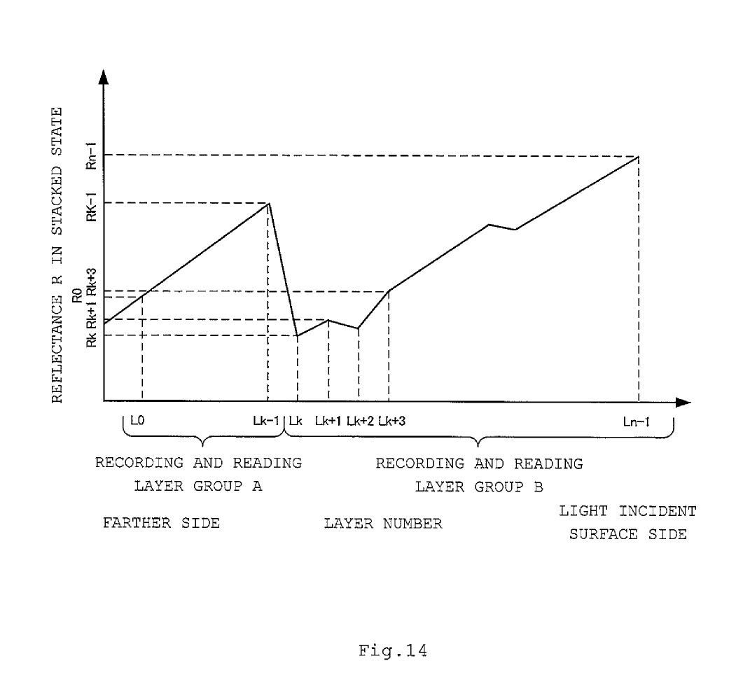

Furthermore, a reflectance Rₖ₋₁ in a stacked state of the recording and reading layer (Lₖ₋₁ layer) positioned closest to the light incident surface side in the recording and reading layer group A is set to be greater than the maximum value of reflectances Rₖ and Rₖ₊₁ of two recording and reading layers (L_{K} layer and Lₖ₊₁ layer) positioned farthest side in the recording and reading layer group B. The recording and reading layer groups A and B are distinguished by this reflectance inversion phenomenon. In other words, in each of the recording and reading layer groups A and B, it is only necessary that a reflectance in a stacked state of a particular recording and reading layer is set to be smaller than the maximum value of reflectances in a stacked state of the two recording and reading layers adjacent thereto on the side closer to the light incident surface. For example, as shown in FIG. 14, it is acceptable in the recording and reading layer group B that the reflectance Rₖ₊₁ in a stacked state of the recording and reading layer (Lₖ₊₁) is greater than the reflectance Rₖ₊₂ in a stacked state of one recording and reading layer (Lₖ₊₂) adjacent thereto on the side closer to the light incident surface and smaller than the reflectance Rₖ₊₃ in a stacked state of the second adjacent recording and reading layer (Lₖ₊₃). In such a state, although there is some increase or decrease within the recording and reading layer group B, the stacked-layer reflectances can be on the decrease as a whole.

Moreover, if a difference between the reflectances Rₖ and Rₖ₋₁ of the Lₖ layer and the Lₖ₋₁ layer is too large, when performing focus servo on the Lₖ layer having a low reflectance, the focus servo is affected by the reflection from the Lₖ₋₁ layer. Thus, the control thereof is more likely to be difficult. In particular, a ratio between Rₖ₋₁ and Rₖ is preferably within 3:1 in view of the focus servo on the Lₖ layer, i.e., Rₖ/Rₖ₋₁≧(⅓), and more preferably within 2:1. In order to realize such a ratio, it is desired to set the reflectance Rₖ₋₁ of the recording and reading layer (Lₖ₋₁ layer) positioned closer to the light incident surface side in the recording and reading layer group A to be approximately the same as or smaller than the reflectance Rₙ₋₁ of the recording and reading layer (Lₙ₋₁ layer) positioned closest to the light incident surface side in the recording and reading layer group B.

Moreover, it is desired to set the reflectance Rₖ in a stacked state of the Lₖ layer to be as low as possible to the extent that such a value can be accepted by the optical recording and reading device. Accordingly, it becomes possible to include a large number of recording and reading layers in the closest recording and reading layer group B. Moreover, as can be seen from the reflected light amount Iₐ of the present light in [Expression 1] shown in the first embodiment, the recording and reading layer group B positioned on the closer side can reduce a monotonic decrease amount of the stacked-layer reflectances (a slope in the graph). Therefore, it is possible to increase the number of recording and reading layers to be allowed to belong to the recording and reading layer group B. Similarly, although the reflectance R₀ of the L₀ layer can take any value smaller than Rₖ₋₁, it is desired to be a value as low as possible to the extent that such a value can be accepted by the optical recording and reading device as with Rₖ. As a result, it is possible to increase the number of recording and reading layers also in the recording and reading layer group A.

Accordingly, it can be seen that the number of recording and reading layers included in the recording and reading layer group B positioned closer to the light incident surface is desirably greater than the number of recording and reading layers included in the recording and reading layer group A. The single-layer reflectance r in the recording and reading layers belonging to the recording and reading layer group A positioned farther from the light incident surface is set to be higher than the single-layer reflectance r in the recording and reading layers belonging to the recording and reading layer group B. Again, as can be seen from the reflected light amount Iₐ of the present light in [Expression 1], a decrease amount in the reflected light amounts of the recording and reading layers included in the farther-side recording and reading layer group A, i.e., a monotonic decrease amount of the stacked-layer reflectances (slopes in the graphs of FIGS. 13 and 14) becomes greater than a monotonic decrease amount of the stacked-layer reflectances in the recording and reading layers included in the closer-side recording and reading layer group B. That is, a variation in stacked-layer reflectance is greater in the recording and reading layers included in the farther-side recording and reading layer group A than in the recording and reading layers included in the closer-side recording and reading layer group B. In order to reduce a variation in stacked-layer reflectances among all of the recording and reading layers under such circumstances, it is desired for the closer-side recording and reading layer group B having less reflectance variation to include layers as many as possible.

Based on the above-described ideas, it is important for the recording and reading layer groups A and B to set a difference between the maximum value and the minimum value of the stacked-layer reflectances in all of the recording and reading layers included in the farther-side recording and reading layer group A to be smaller than a difference between the maximum value and the minimum value of the stacked-layer reflectances in all of the recording and reading layers included in the closer-side recording and reading layer group B.

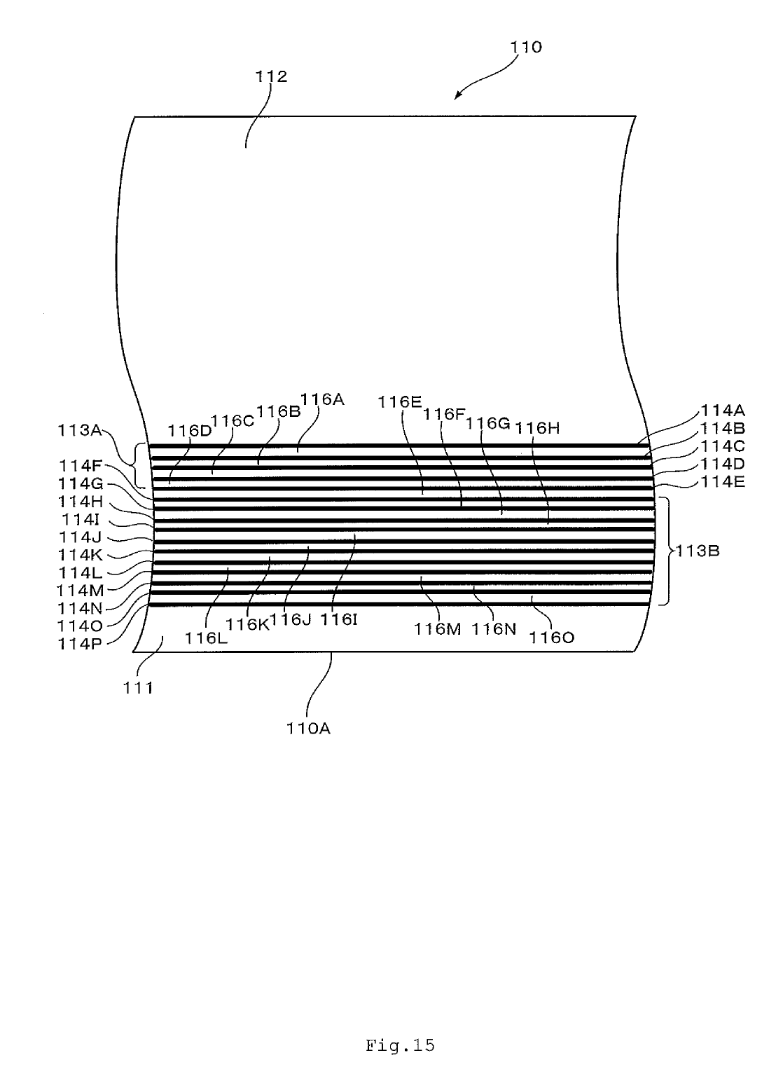

FIGS. 15, 16, and 17 show an example of a multilayer optical recording medium 110 having a plurality of recording and reading layer groups configured specifically based on the above-described design concept according to the second embodiment. Note that reference numerals for elements to be used in the following description have last two digits identical to those of the reference numerals used in the description of the multilayer optical recording medium 10 already shown in the first embodiment, and the detailed description thereof is therefore omitted.

In the multilayer optical recording medium 110, L0 to L15 recording and reading layers 114A to 114P, which are 16 layers, are stacked in the order starting from the side farthest from a light incident surface thereof. Moreover, each of first to fifteenth intermediate layers 116A to 116O is stacked between corresponding ones of the L0 to L15 recording and reading layers 114A to 114P.

Furthermore, the multilayer optical recording medium 110 includes first and second recording and reading layer groups 113A and 113B. Each of the first and second recording and reading layer groups 113A and 113B is configured to include a plurality of recording and reading layers which are sequential in the order of stacking. In each of the groups, stacked-layer reflectances in the recording and reading layers are approximately the same or decreased from the side closer to the light incident surface toward the side farther from the light incident surface.

In particular, the first recording and reading layer group 113A has a structure of 5 layers including the L0 to L4 recording and reading layers 114A to 114E, and the second recording and reading layer group 113B has a structure of 11 layers including the L5 to L15 recording and reading layers 114F to 114P. The number of recording and reading layers in the farther-side first recording and reading layer group 113A is set to be smaller than the number of recording and reading layers in the closer-side second recording and reading layer group 113B.

Within each of the recording and reading layer groups 113A and 113B, a stacked-layer reflectance of a recording and reading layer belonging thereto is set to be smaller than the maximum value of the stacked-layer reflectances of the two recording and reading layers adjacent to the recording and reading layer on the light incident surface side. For example, in the first recording and reading layer group 113A, the stacked-layer reflectance of the L1 recording and reading layer 114B is set to be smaller than the greater one of the stacked-layer reflectances of the two L2 and L3 recording and reading layers 114C and 114D adjacent thereto on the light incident surface side. As far as the first recording and reading layer group 113A is concerned, for the L3 recording and reading layer 114D, only one layer, the L4 recording and reading layer 114E, is adjacent thereto on the light incident surface side. Therefore, the stacked-layer reflectance of the L3 recording and reading layer 114D is set to be smaller than the stacked-layer reflectance of the L4 recording and reading layer 114E. If each of the recording and reading layer groups 113A and 113B satisfies such conditions, the stacked-layer reflectances in each group can be reduced from the light incident surface side toward the side farther therefrom while allowing some increase or decrease.

Accordingly, the stacked-layer reflectances of the recording and reading layers in each of the recording and reading layer groups 113A and 113B can have a decreasing trend toward the farther side. Thus, when reading a particular recording and reading layer, it is possible to suppress the reflected light from the recording and reading layer adjacent thereto on the farther side from mixing with the reading light. As a result, even if a thickness of the intermediate layer is reduced, it becomes possible to suppress crosstalk. Thus, it is possible to increase the number of recording and reading layers in each of the recording and reading layer groups 113A and 113B.

The first recording and reading layer group 113A and the second recording and reading layer group 113B are adjacent to each other with an intermediate layer interposed therebetween. With regard to the recording and reading layer groups 113A and 113B adjacent to each other, the stacked-layer reflectance of the L4 recording and reading layer 114E positioned closest in the farther-side recording and reading layer group 113A is higher than the maximum value of the stacked-layer reflectances of the two layers (i.e., the L5 recording and reading layer 114F and the L6 recording and reading layer 114G) positioned farthest in the second recording and reading layer group 113B closer to the light incident surface (herein, the stacked-layer reflectance of the L6 recording and reading layer 114G). That is, when observed in the order starting from the light incident surface side, the stacked-layer reflectances are decreased, in the order of stacking, from the L15 recording and reading layer 114P to the L5 recording and reading layer 114F, but the stacked-layer reflectance is increased at the L4 recording and reading layer 114E from those of at least two layers adjacent thereto on the closer side. Thereafter, the stacked-layer reflectances are again decreased in the order of stacking up to the L0 recording and reading layer 114A.

Moreover, in these recording and reading layer groups 113A and 113B, the maximum value of the stacked-layer reflectances in all of the L0 to L4 recording and reading layers 114A to 114E included in the farther-side first recording and reading layer group 113A is set to be the same as or smaller than the maximum value of the stacked-layer reflectances in all of the L5 to L15 recording and reading layers 114F to 114P included in the closer-side second recording and reading layer group 113B. In particular, the stacked-layer reflectance of the closest L4 recording and reading layer 114E in the first recording and reading layer group 113A is set to be the same as or smaller than the stacked-layer reflectance of the closest L15 recording and reading layer 114P in the second recording and reading layer group 113B.

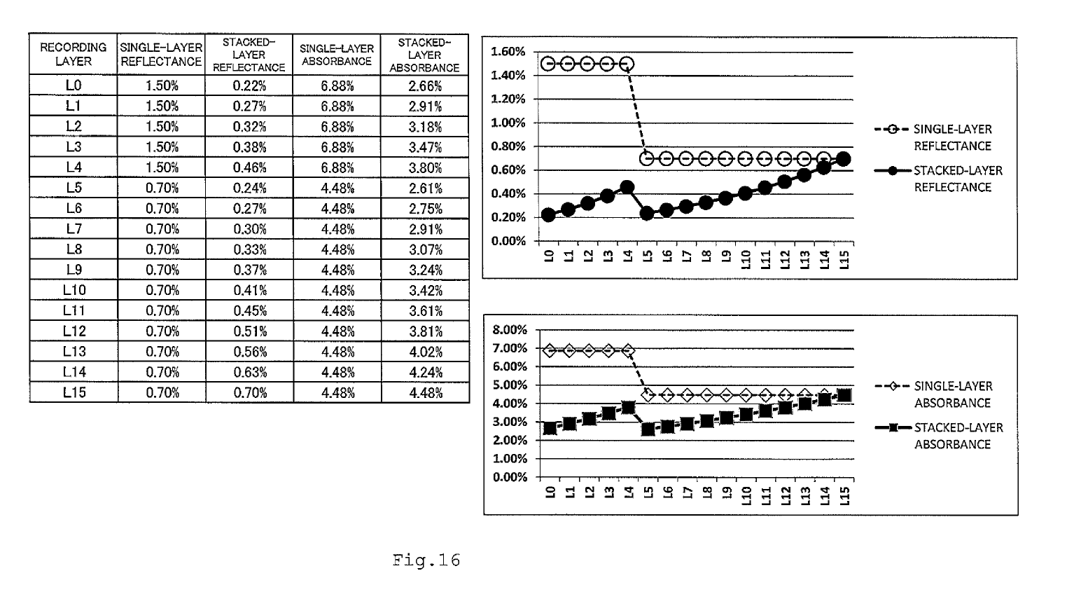

As a film design for realizing such stacked-layer reflectances, the L0 to L4 recording and reading layers 114A to 114E belonging to the first recording and reading layer group 113A are set to have a first single-layer reflectance as a reflectance in a single-layer state (hereinafter, referred to as single-layer reflectance), and set to have a first single-layer absorbance as an absorbance in a single-layer state (hereinafter, referred to as single-layer absorbance) as shown in FIG. 16. In particular, the first single-layer reflectance is set to 1.5%, and the first single-layer absorbance is set to 6.9%.

Moreover, with regard to the second recording and reading layer group 113B positioned closer to the light incident surface side, the L5 to L15 recording and reading layers 114F to 114P belonging thereto are set to have a second single-layer reflectance and a second single-layer absorbance which are smaller than the first single-layer reflectance and the first single-layer absorbance, respectively. In particular, the second single-layer reflectance is set to 0.7%, and the second single-layer absorbance is set to 4.5%.

In the multilayer optical recording medium 110, the L0 to L4 recording and reading layers 114A to 114E in the first recording and reading layer group 113A are set to have approximately the same single-layer reflectances and single-layer absorbances. The L5 to L15 recording and reading layers 114F to 114P in the second recording and reading layer group 113B are also set to have approximately the same single-layer reflectances and single-layer absorbances. As a result, in both of the first recording and reading layer group 113A and the second recording and reading layer group 113B, the stacked-layer reflectances are monotonically decreased in the order starting from the light incident surface side. On the other hand, optical constants such as single-layer reflectances and single-layer absorbances are set to be different from each other between the first recording and reading layer group 113A and the second recording and reading layer group 113B. In particular, the single-layer reflectance in the first recording and reading layer group 113A is higher than that in the second recording and reading layer group 113B. As a result, the stacked-layer reflectance of the L4 recording and reading layer 114E becomes higher than the stacked-layer reflectance of the L5 recording and reading layer 114F.

Moreover, between the recording and reading layer groups 113A and 113B in the multilayer optical recording medium 110, a difference between the maximum value and the minimum value in all of the stacked-layer reflectances of the L0 to L4 recording and reading layers 114A to 114E included in the farther-side first recording and reading layer group 113A is smaller than a difference between the maximum value and the minimum value in all of the stacked-layer reflectances of the L5 to L15 recording and reading layers 114F to 114P included in the closer-side second recording and reading layer group 113B.

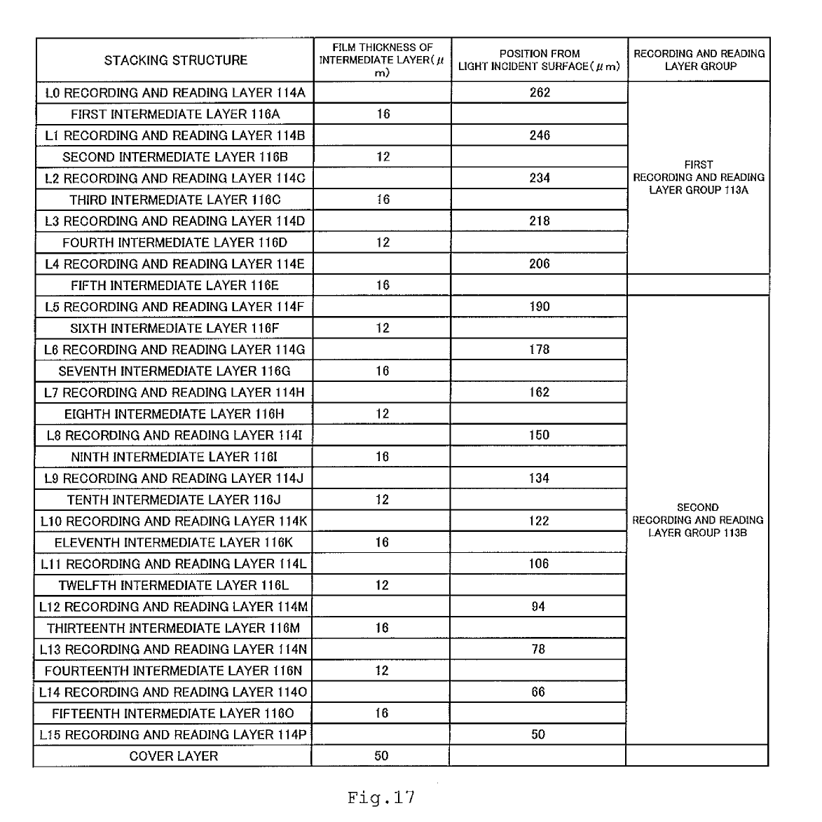

As shown in FIG. 17, film thicknesses of the intermediate layers 116A to 116O are set to have the first distance T1 (12 μm) greater than or equal to 10 μm and the second distance T2 (16 μm) greater than the first distance by 3 μm or more in an alternate manner. In this multilayer optical recording medium 110, the intermediate layers having two kinds of film thicknesses (16 μm and 12 μm) are stacked in an alternate manner in the order starting from the farthest side, i.e., the first intermediate layer 116A is 16 μm the second intermediate layer 116B is 12 μm the third intermediate layer 116C is 16 μm the fourth intermediate layer 116D is 12 μm the fifth intermediate layer 116E is 16 μm the sixth intermediate layer 116F is 12 μm, and so on.

Furthermore, in the multilayer optical recording medium 110, the fifth intermediate layer 116E interposed between the first recording and reading layer group 113A and the second recording and reading layer group 113B is set to have the second distance T2 (16 μm) which is a larger one of the film thicknesses. Therefore, the fifth intermediate layer 116E is set to have the film thickness greater than those of the fourth intermediate layer 116D and the sixth intermediate layer 116F adjacent to the both sides thereof with the L4 recording and reading layer 114E and the L5 recording and reading layer 114F respectively interposed therebetween. As previously mentioned, between the L4 recording and reading layer 114E and the L5 recording and reading layer 114F, interlayer crosstalk is more likely to occur since the stacked-layer reflectance of the farther-side L4 recording and reading layer 114E becomes greater than (reversed from) that of the L5 recording and reading layer 114F. In view of this, a film thickness of the fifth intermediate layer 116E interposed therebetween is increased to reduce the interlayer crosstalk.

In this multilayer optical recording medium 110, the stacked-layer reflectances thereof are designed to be divided into two or more groups, e.g., the first and second recording and reading layer groups 113A and 113B. As a result, a difference between the stacked-layer reflectance of the L15 recording and reading layer 114P closest to the light incident surface and the stacked-layer reflectance of the L0 recording and reading layer 114A farthest from the light incident surface becomes small. In particular, with regard to all of the L0 to L15 recording and reading layers 114A to 114P, the largest stacked-layer reflectance in those layers falls within 5 times as large as the smallest stacked-layer reflectance. Preferably, the largest stacked-layer reflectance is set to fall within four times as much as the smallest one, and desirably set to fall within three times as much as the smallest one. Actually, it falls within less than four times despite of the 16-layer configuration. The same holds for within each of the recording and reading layer groups 113A and 113B.

Moreover, with the employment of such a stacking structure, recording and reading layers having the same film material and film thickness are stacked within each of the recording and reading layer groups 113A and 113B. Thus, the design load and manufacturing load thereof can be significantly reduced. Moreover, also on the side of the optical recording and reading device 90, a variation in recording and reading conditions is reduced since the recording and reading layers having substantially the same characteristics are stacked within each of the recording and reading layer groups 113A and 113B. Thus, the recording and reading control thereof can be simplified. That is, the simplified design leads to the simplified manufacturing, and the quality of the multilayer optical recording medium is thereby stabilized and the recording and reading control thereof is therefore simplified. Such a positive cycle can be thus created.

Next, a description will be given of a method for performing recording or reading on or from the multilayer optical recording medium 110 using the optical recording and reading device 90 of the second embodiment.

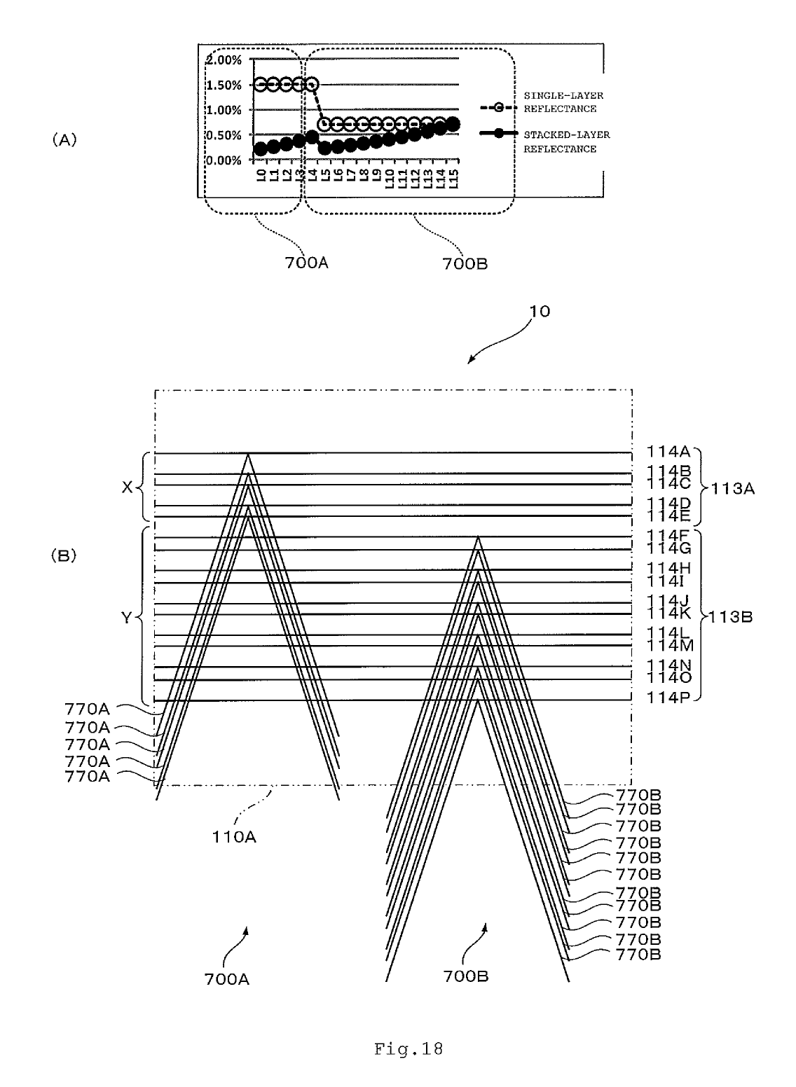

As shown in FIG. 18B, the first beams 770A of the first optical pickup 700A in the optical recording and reading device 90 of the present embodiment perform recording or reading on or from the first recording and reading layer group 113A (L0 to L4 recording and reading layers 114A to 114E). Also, the second beams 770B of the second optical pickup 700B perform recording or reading on or from the second recording and reading layer group 113B (the L5 to L15 recording and reading layers 114F to 114P). That is, in the present embodiment, the first recording and reading layer group 113A corresponds to the first target recording and reading layers to be recorded or read by the first beams 770A, and the second recording and reading layer group 113B corresponds to the second target recording and reading layers to be recorded or read by the second beams 770B.

As a result, the first recording and reading layer group 113A to be the first target and the second recording and reading layer group 113B to be the second target are different recording and reading layers, respectively. With reference to the light incident surface 110A side, the first recording and reading layer group 113A to be the first target is placed farther than the second recording and reading layer group 113B to be the second target.

As previously mentioned, an average emitting power of the first beam 770A when recording is set to be higher than that of the second beam 770B when recording.

Therefore, according to the recording and reading method using the optical recording and reading device 90 of the present embodiment, information can be simultaneously recorded or read by irradiating the first recording and reading layer group 113A with the first beam 770A and irradiating the second recording and reading layer group 113B with the second beam 770B at the same time. Accordingly, an information transfer rate when recording or reading can be significantly improved.

Furthermore, it is only necessary that the first optical pickup 700A makes the first beam 770A focus on the first recording and reading layer group 113A positioned in a farther-side region X in the thickness direction of the multilayer optical recording medium 110, and the second optical pickup 700B makes the second beam 770B focus on the second recording and reading layer group 113B positioned in a closer-side region Y in the thickness direction of the multilayer optical recording medium 110. As a result, each of the first and second optical pickups 700A and 700B can reduce a focus moving range thereof, thereby being able to narrow a spherical aberration correction range thereof.

Moreover, in the multilayer optical recording medium 110 of the present embodiment, all of the L0 to L4 recording and reading layers 114A to 114E belonging to the first recording and reading layer group 113A to be recorded or read by the first optical pickup 700A are set to have approximately the same single-layer reflectances and single-layer absorbances. In addition, all of the L5 to L15 recording and reading layers 114F to 114P belonging to the second recording and reading layer group 113B to be recorded or read by the second optical pickup 700B are set to have approximately the same single-layer reflectances and single-layer absorbances.

As a result, as shown in FIG. 18A, within the first recording and reading layer group 113A to be a recording and reading target (first target) of the first optical pickup 700A, stacked-layer reflectances are monotonically decreased in the order starting from the light incident surface 110A side. Similarly, within the second recording and reading layer group 113B to be a recording and reading target (second target) of the second optical pickup 700B, stacked-layer reflectances are monotonically decreased in the order starting from the light incident surface 110A side. Accordingly, it is only necessary for each of the first and second optical pickups 700A and 700B to control the recording and reading power thereof in accordance with the stacked-layer reflectances monotonically varied in the stacking order. Therefore, it becomes possible to simplify the power control when recording and reading.

As shown in FIG. 16, a variation range of the stacked-layer reflectances in the first recording and reading layer group 113A and a variation range of the stacked-layer reflectances in the second recording and reading layer group 113B are relatively close to each other. Therefore, in a case where the first recording and reading layer group 113A corresponds to the first target recording and reading layers and the second recording and reading layer group 113B corresponds to the second target recording and reading layers, it is preferred to use the same laser as the first light source 701A and the second light source 701B.

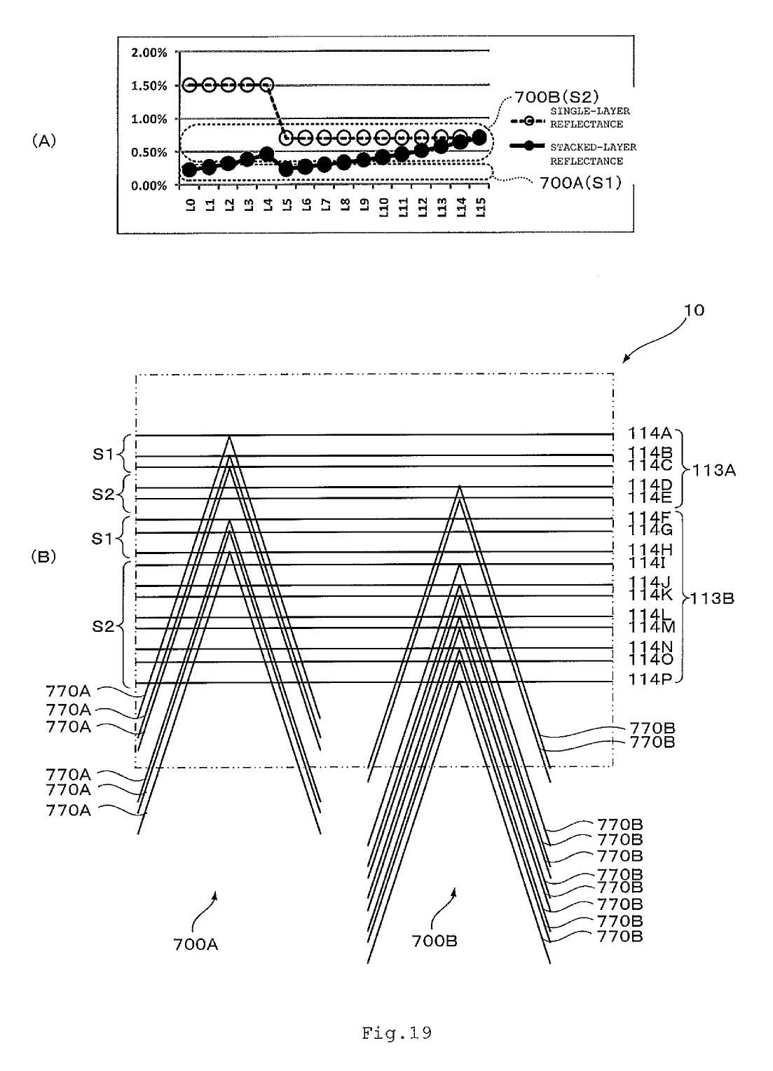

On the other hand, as illustrated by way of example in FIG. 19B, for example, it is possible to perform grouping of recording and reading layers to be a first target S1 and grouping of recording and reading layers to be a second target S2 based on the order of stacked-layer reflectances in all of the L0 to L15 recording and reading layers 114A to 114P, independently of the division between the first recording and reading layer group 113A and the second recording and reading layer group 113B. In particular, as shown in FIG. 19A, grouping is herein performed so that a recording and reading layer having a stacked-layer reflectance smaller than 0.35% belongs to the first target S1 and a recording and reading layer having a stacked-layer reflectance of 0.35% or more belongs to the second target S2. In particular, the L0, L1, and L2 recording and reading layers 114A, 114B, and 114C belonging to the first recording and reading layer group 113A and the L5, L7, and L8 recording and reading layers 114F, 114G, and 114H belonging to the second recording and reading layer group 113B correspond to the first target S1. The L3 and L4 recording and reading layers 114D and 114E belonging to the first recording and reading layer group 113A and the L9 to L15 recording and reading layers 1141 to 114P belonging to the second recording and reading layer group 113B correspond to the second target S2. That is, the recording and reading layers to be the first target S1 belong to two or more of recording and reading layer groups 113A and 113B, and the recording and reading layers to be the second target S2 also belong to two or more of recording and reading layer groups 113A and 113B. As observed in the stacking order, the recording and reading layers of the first target S1 and the recording and reading layers of the second target S2 are disposed in an alternate manner.

As shown in FIG. 19, if the grouping of the first target S1 and that of the second target S2 are performed on the basis of the order of stacked-layer reflectances, the first optical pickup 700A consequently performs recording or reading on or from recording and reading layers having low stacked-layer reflectances on average as in the first embodiment. Thus, a high-power dedicated laser can be used as the first light source 701A. Also, since the second optical pickup 700B consequently performs recording or reading on or from recording and reading layers having high stacked-layer reflectances on average, a low-power dedicated laser can be used as the second light source 701B.

That is, the first and second optical pickups 700A and 700B have divided required dynamic ranges. As a result, it is possible to increase a ratio between the stacked-layer reflectance (R₁₅) of the L15 recording and reading layer 114P positioned closest to the light incident surface side and the stacked-layer reflectance (R₀) of the L0 recording and reading layer 114A positioned farthest therefrom.

The second embodiment illustrates, by way of example, the multilayer optical recording medium 110 having the structure of the two recording and reading layer groups each having stacked-layer reflectances decreased in the stacking order starting from the light incident surface side. However, it is also preferable that the multilayer optical recording medium 110 have three or more recording and reading layer groups. Moreover, the second embodiment illustrates, by way of example, a case where the deposition conditions are caused to coincide with one another in each recording and reading layer group so as to monotonically decrease stacked-layer reflectances thereof. However, the deposition conditions of the recording and reading layers in each recording and reading layer group may not always be caused to coincide with one another. In the case of not being caused to coincide with one another, some increase or decrease in stacked-layer reflectances within each of the recording and reading layer groups is acceptable, and it is only necessary that the stacked-layer reflectances thereof be on the decrease as a whole. In particular, the stacked-layer reflectance of a particular recording and reading layer is set to be smaller than the maximum value of the stacked-layer reflectances in the two recording and reading layers adjacent to the particular recording and reading layer on the light incident surface side. For example, the stacked-layer reflectance of the L5 recording and reading layer 114F only needs to be designed smaller than the greater one of the stacked-layer reflectances of the L6 and L7 recording and reading layers 114G and 114H adjacent thereto on the light incident surface side (herein, the L7 recording and reading layer 114H).

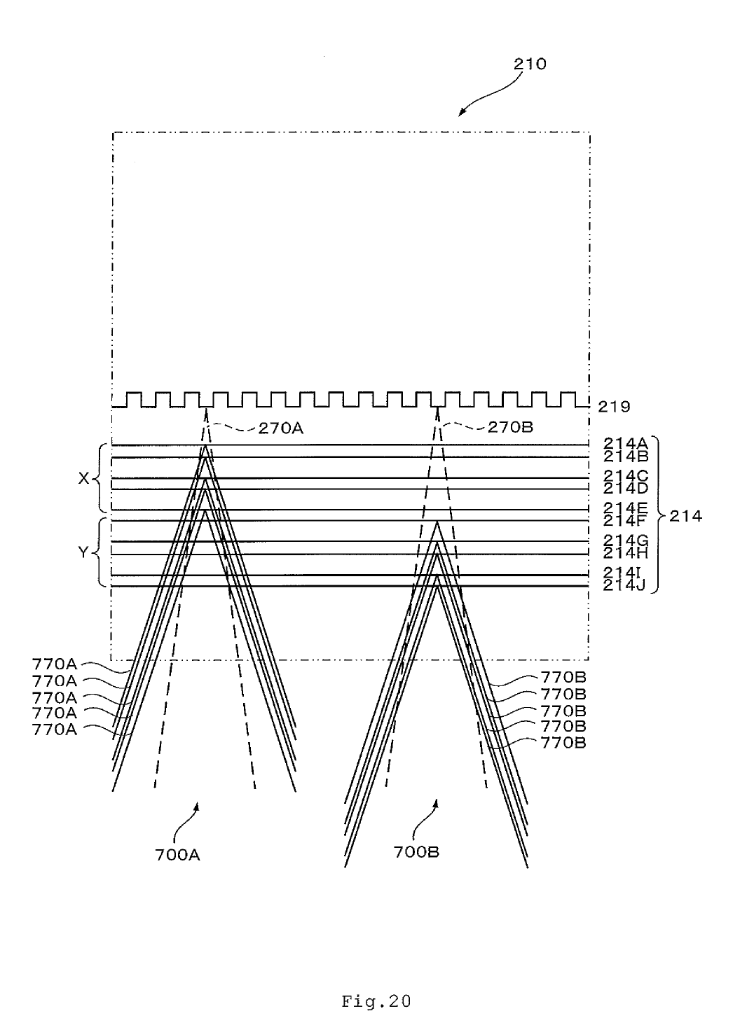

Furthermore, although each of the above-described first and second embodiments shows a case where grooves and lands are formed on each recording and reading layer of the multilayer optical recording medium, the present invention is not limited thereto. For example, as in a multilayer optical recording medium 210 shown in an enlarged manner in FIG. 20, it may include a recording and reading layer group 214 with no tracking control concave-convex pattern, and a servo layer 219 having a tracking control concave-convex pattern or grooves. In this case, each of the first and second optical pickups 700A and 700B may be provided with a tracking optical system, and the first and second beams 770A and 770B may be irradiated to perform recording or reading on or from the recording and reading layer group 214 while irradiating tracking-dedicated beams 270A and 270B to the servo layer 219 to perform tracking. Needless to say, in a case where recording and reading are performed with the first optical pickup 700A, for example, without providing tracking optical systems provided in the first and second optical pickups 700A and 700B, it is also possible to perform tracking control by making the second optical pickup 700B irradiate the servo layer 219. Similarly, when recording or reading with the second optical pickup 700B, it is also possible to perform tracking control by making the first optical pickup 700A irradiate the servo layer 219.

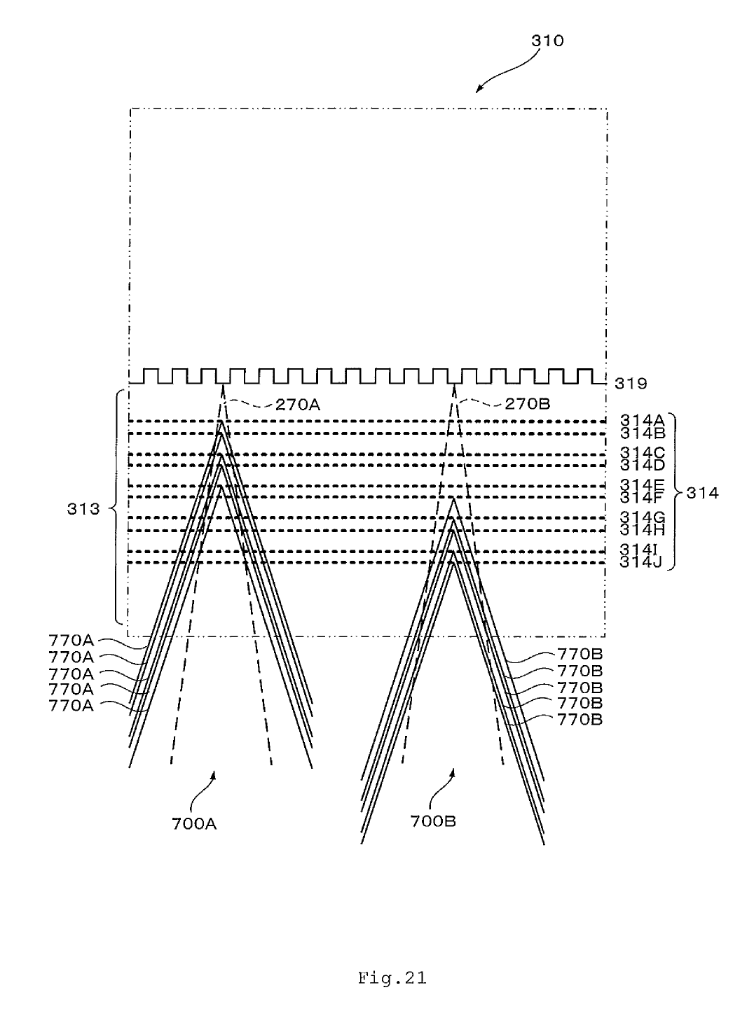

Moreover, although FIG. 20 shows a limited case where the recording and reading layer group has been deposited in advance, the present invention is not limited thereto. As in a multilayer optical recording medium 310 shown in FIG. 21, for example, an entire area that can be a recording and reading layer group in the future may be formed as a bulk 313 having a predetermined thickness. If the recording beams 770A and 770B are irradiated to the bulk 313, only the focal portions of the beam spots undergo a change in state, and recording marks are thereby formed. That is, the recording and reading layers of the multilayer optical recording medium may also include ones formed according to a case where recording marks are formed as needed on the planar region of the bulk 313, and a multilayer structure of recording and reading layers 314A to 314J is eventually formed as an aggregate of such recording marks.

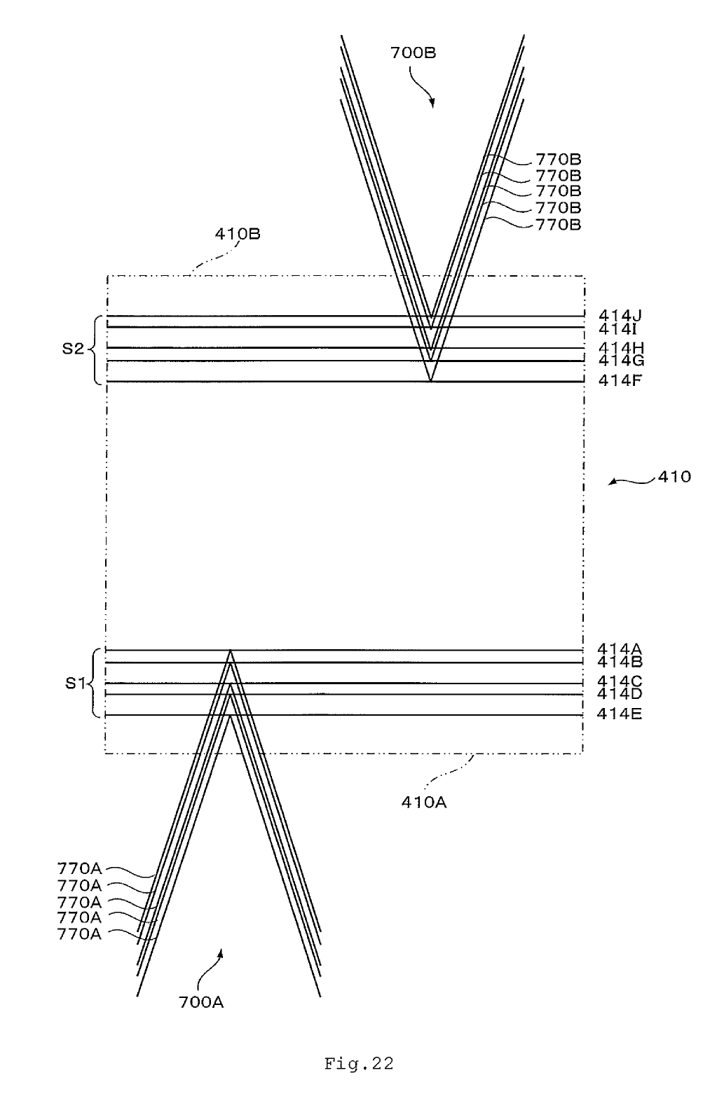

Moreover, although the optical recording and reading device 90 of the present embodiment is illustrated as a case where the first and second optical pickups 700A and 700B are disposed on one surface side of the multilayer optical recording medium 10 or 110, the present invention is not limited thereto. As shown in FIG. 22, for example, the first optical pickup 700A may be disposed on the side of one surface 410A of a multilayer optical recording medium 410, and the second optical pickup 700B may be disposed on the side of the other surface 410B of the multilayer optical recording medium 410. Then, it is preferable that a plurality of recording and reading layers 414A to 414E to be the first target S1 be disposed on the side of the one surface 410A of the multilayer optical recording medium 410 and a plurality of recording and reading layers 414F to 414J to be the second target S2 be disposed on the side of the other surface 410B of the multilayer optical recording medium 410.

In the optical recording and reading device 90 of the present embodiment, a case where the first and second optical pickups 700A and 700B are simultaneously controlled by the recording and reading control device 95 to record information simultaneously on a plurality of recording and reading layers or read information simultaneously from the plurality of recording and reading layers has been described by way of example. However, the present invention is not limited thereto, and the first and second optical pickups 700A and 700B may be operated separately to perform recording and reading separately.

It is to be understood that the optical recording and reading device and the optical recording and reading method of the present invention is not limited to the embodiments described above, and various modifications are possible without departing from the scope of the invention.

The optical recording and reading device and the optical recording and reading method of the present invention can be widely applied to various optical recording media such as those having a plurality of recording and reading layers.

The entire disclosure of Japanese Patent Application No. 2011-50920 filed on Mar. 9, 2011 including specification, claims, drawings, and summary are incorporated herein by reference in its entirety.

1. An optical recording and reading device for recording or reading information by means of light irradiation on or from an optical recording medium having a plurality of recording and reading layers that are stacked in advance or eventually formed, the device comprising:
a first optical system for irradiating a first beam to the recording and reading layer to be a first target to perform recording or reading of information; and
a second optical system for irradiating a second beam to the recording and reading layer to be a second target to perform recording or reading of information.

2. The optical recording and reading device according to claim 1, wherein an average emitting power of the first beam by the first optical system when recording or reading and an average emitting power of the second beam by the second optical system when recording or reading are different from each other.

3. The optical recording and reading device according to claim 1, wherein a rated output of a first light source of the first optical system and a rated output of a second light source of the second optical system are different from each other.

4. The optical recording and reading device according to claim 1, wherein the first optical system and the second optical system are disposed on a light incident surface side of the optical recording medium.

5. The optical recording and reading device according to claim 1, wherein
with reference to the light incident surface side of the optical recording medium, the recording and reading layer to be the first target is placed farther than the recording and reading layer to be the second target, and
the average emitting power of the first beam by the first optical system when recording or reading is higher than the average emitting power of the second beam by the second optical system when recording or reading.

6. The optical recording and reading device according to claim 1, wherein the optical recording medium includes a plurality of the recording and reading layers of the first target and a plurality of the recording and reading layers of the second target.

7. The optical recording and reading device according to claim 1, comprising a recording and reading control device for simultaneously controlling the first and second optical systems to simultaneously record or read information on or from the recording and reading layer of the first target and the recording and reading layer of the second target.

8. The optical recording and reading device according to claim 1, wherein an optical constant of the recording and reading layer of the first target and an optical constant of the recording and reading layer of the second target are substantially the same in the optical recording medium.

9. The optical recording and reading device according to claim 1, wherein a material composition and a film thickness of the recording and reading layer of the first target and a material composition and a film thickness of the recording and reading layer of the second target are substantially the same in the optical recording medium, respectively.

10. The optical recording and reading device according to claim 1, wherein:
the optical recording medium includes at least two or more recording and reading layer groups, each group composed of a plurality of the recording and reading layers sequential in a stacking order;
within the recording and reading layer group, reflectances in a stacked state of the recording and reading layers are set to be substantially the same or decreased from a side closer to a light incident surface toward a side farther from the light incident surface; and
the recording and reading layer of the first target and the recording and reading layer of the second target belong to any of the two or more recording and reading layer groups.

11. The optical recording and reading device according to claim 10, wherein the optical constants of the recording and reading layers belonging to the same recording and reading layer group are substantially the same, and
the optical constant of the recording and reading layer belonging to one of the plurality of recording and reading layer groups and the optical constant of the recording and reading layer belonging to another one of the plurality of recording and reading layer groups are different from each other.

12. The optical recording and reading device according to claim 10, wherein the recording and reading layer of the first target belongs to a first one of the recording and reading layer groups, and the recording and reading layer of the second target belongs to a second one of the recording and reading layer groups.

13. The optical recording and reading device according to claim 10, wherein the recording and reading layers of the first target belong to two or more groups among the recording and reading layer groups, and the recording and reading layers of the second target belong to two or more groups among the recording and reading layer groups.

14. An optical recording and reading method for recording or reading information by means of light irradiation on or from an optical recording medium having a plurality of recording and reading layers that are stacked in advance or eventually formed, the method comprising:
a first step of irradiating a first beam to the recording and reading layer to be a first target to perform recording or reading of information; and
a second step of irradiating a second beam to the recording and reading layer to be a second target to perform recording or reading of information.

15. The optical recording and reading method according to claim 14, wherein,
with reference to a light incident surface side of the optical recording medium, the recording and reading layer to be the first target is placed farther than the recording and reading layer to be the second target; and
an average emitting power of the first beam when recording or reading is higher than an average emitting power of the second beam when recording or reading.

16. The optical recording and reading method according to claim 14, wherein the first step and the second step are simultaneously performed to simultaneously record or read information on or from the recording and reading layer of the first target and the recording and reading layer of the second target.

17. The optical recording and reading method according to claim 14, wherein an optical constant of the recording and reading layer of the first target and an optical constant of the recording and reading layer of the second target are substantially the same in the optical recording medium.

18. The optical recording and reading method according to claim 14, wherein
the optical recording medium includes at least two or more recording and reading layer groups, each group composed of a plurality of the recording and reading layers sequential in a stacking order;
within the recording and reading layer group, reflectances in a stacked state of the recording and reading layers are set to be substantially the same or decreased from a side closer to a light incident surface toward a side farther from the light incident surface; and
the recording and reading layer of the first target to be recorded or read in the first step and the recording and reading layer of the second target to be recorded or read in the second step belong to any of the two or more recording and reading layer groups.
